(19) United States
(12) Patent Application Publication
(10) Pub. No.: US 2005/0053008 A1
(43) Pub. Date: Mar. 10, 2005

(54) Wireless device isolation in a controlled RF test environment

(76) Inventors: John Robert Griesing, Sudbury, MA (US); Steven A. Mulawski, Tyngsborough, MA (US); Francis Fothergill, Reading, MA (US); James E. Moran, Methuen, MA (US); Fanny I. Mlinarsky, Bolton, MA (US); Charles R. Wright, Winchester, MA (US)

Correspondence Address: David D. Lowry, Esq.;Brown Rudnick Berlack Israels LLP, One Financial Center, Boston, MA, 02111, US

(21) Appl. No.: 10/960,548

(22) Filed: Oct. 7, 2004

Related U.S. Application Data
(63) Continuation-in-part of application No. 10/776,413, filed on Feb. 11, 2004.
Application No. 10/776,413 is a continuation of application No. 10/379,281, filed on Mar. 4, 2003, now Pat. No. 6,724,730.
(60) Provisional application No. 60/361,572, filed on Mar. 4, 2002.

(51) Int. Cl. H04L 1/00; H04J 3/14

(52) U.S. Cl. 370/241

(57) ABSTRACT

A system and method for testing wireless devices in a simulated a wireless environment is provided. RF modules for creating and receiving RF signals in a test environment are also provided. Features include RF isolation of a wireless device, including filtering signals on electrical paths to and from the device, and circuits to reduce undesired RF signals on such electrical paths, for example PCI bus paths. The system and method also include a test enclosure with isolation chambers with filtered electrical signal paths to allow testing of wireless devices inserted into the isolation chambers. This system and method also allows controlled testing of antennae diversity features of the wireless device.

### RELATED APPLICATIONS

The present application is a continuation-in-part of pending U.S. patent application Ser. No. 10/776,413 filed on Feb. 11, 2004, which is a continuation of application Ser. No. 10/379,281 filed on Mar. 4, 2003, now issued U.S. Pat. No. 6,724,730, which claims benefit of provisional patent application 60/361,572 filed on Mar. 4, 2002, which are incorporated herein by reference.

### FIELD OF THE INVENTION

The present disclosure relates generally to the testing of communication devices and more particularly to a method and system for testing wireless computer network communication devices under various simulated operating conditions.

### BACKGROUND OF THE INVENTION

Computer networks are well known and are widely used in a variety of businesses. Currently, there are many different types of wired computer networks available for personal and business use, such as Ethernet, Token-Ring, Gigabit Ethernet, ATM (Asynchronous Transfer Mode), IP, with wired Ethernet being the most popular by far. The emerging Local Area Networks (LANs) are typically based on the IEEE 802.11 standard. Due to the popularity of the Ethernet network, a number of devices and methods were developed to test the Ethernet communication systems. However, as wireless computer network communication systems become less expensive to implement and maintain, they are becoming more prevalent and more widely used to communicate data among nodes of a local area network (LAN). One advantage the wireless network system has over other existing types of network communication systems is the lack of communication wire/cable. Wireless network systems allow for a large number of computer nodes to be communicated together without all of the cumbersome communication wires (such as Ethernet wires) required by non-wireless communication systems and thus provides for a more efficient use of space. Another advantage the wireless network system has over other existing types of network communication systems is that, in buildings which do not already have a wired network infrastructure, wireless systems are much easier and cheaper to implement.

However, unlike with the Ethernet network system, wireless communication networks lack sufficient means and methods for verifying performance, interoperability and compliance with the wireless standards. Although there are many reasons for the lack of testing devices and methods, development of testing devices and methods appeared to be mostly hindered by several factors, including the increased complexity of the wireless communication system as compared to the wired communication system. This increased complexity is a necessary element required to increase the reliability of the wireless system and to achieve a useful level of performance. An additional hindering factor includes the network boundaries. Unlike wired systems, wireless systems have vague network boundaries and thus, the testing of wireless networks require special considerations in order to avoid interference with other wireless systems not involved in the testing procedure. Another factor is that the communication protocols have not matured and are thus in a constant state of flux due to continued standards activity. Lastly, because many wireless equipment manufacturers began by designing and manufacturing traditional wired network systems, they typically lack an expertise with wireless equipment and thus with wireless communications issues.

As such, current methods for testing wireless communications equipment typically range from simply setting up the test in an open air environment to connecting the wireless equipment together via cables, to assembling test setups disposed within radio frequency (“RF”) shielded rooms. Although open air test setups have the advantage of being simple to construct, they typically suffer from a variety of problems. First, the open air environment is difficult to control. It is not possible to precisely control signal levels and test topologies in order to verify protocol implementation. Often, due to intermittent interference, specific tests cannot be repeated with consistent results. Second, each test system takes up at least one radio channel and because radio channels are regulated and allotted by the government they are a scarce resource. Thus, an active test lab may use all of the allotted channels for one test setup thereby preventing multiple independent test setups from operating simultaneous and preventing multiple engineers or production workers from working side by side. However, one way to overcome the limitations of the open air test setup is by connecting the test setup to wireless equipment through an RF cable system having RF cables, RF combiners and RF attenuators. Using this approach, transmitter signals can be communicated to the wireless system receivers via the RF cable system. Not only does this allow the signal power levels to be controlled using RF attenuators, but the setup can support flexible network topologies in a controlled environment under repeatable test conditions.

While this may be an improvement over the open air test setup, interference issues are still present. One of these interference issues involves the ability to set up a test system in a small area while allowing other test systems to operate nearby, such as on an adjacent test bench. Unfortunately, because a great number of wireless systems have extremely sensitive receivers in order to operate over a useful range of distances between transmitter and receiver, this is impractical. Flexible cables that are used for these test setups do not provide a sufficient level of RF isolation to allow for more than one interference-free test setup in the same lab. Thus, if multiple test setups are used, signals from the transmitters of one test setup can leak from the cables and infiltrate the receivers of the other test setups, greatly degrading the reliability and validity of the test results.

Although RF shielded rooms can provide for an isolated environment, these rooms are expensive to build and maintain and typically require a substantial amount of space. Additionally, the problem of running multiple test setups in the same shielded room remain because although the shielded room isolates the test setup from RF interference sources located outside of the shielded room, it does not isolate the test setup from RF interference sources within the shield room. Moreover, because of the expense of the shielded rooms, they are typically shared among many engineers who may have different needs for the room. Thus, because assembling and disassembling a test setup may range from many hours to several days, there is an incentive to not change the test setup very often, thus limiting the productivity of the test organization. Furthermore, an additional cost of testing wireless systems includes the purchase of specialized equipment for performing, coordinating, automating and synchronizing the tests. The current art requires that the test system be assembled from commodity components and because these components were most likely not designed to solve the whole problem, the components typically must be integrated into a working system. Once the test system has been assembled, test software typically must be developed in order to automate the testing process and, depending on the complexity of the test setup, a significant effort may be needed to develop the control software. This takes additional time, effort, expertise and represents a significant labor cost.

Moreover, unless tight regulations are developed and maintained, each test setup will be different and because each setup was constructed from components not specifically suited to the job, each component of the test setup can have its own method of programming. As a result of this lack of basic integration, it is very difficult to arrange tests that require coordination of RF transmissions. This whole effort is typically very expensive, time consuming and inefficient for the wireless equipment manufacturers. Moreover, the cost of this setup is further exacerbated by the cost of equipment integration, calibration and customized test software development. Tests that involve overlapping BSSs (Basic Service Sets), roaming and hidden stations are difficult to set up and perform because they typically require flexible control over wireless network topology thus requiring wireless stations and access points to be carried around or wheeled on carts.

Thus, there is a need for a test system that provides a flexible cabled environment for RF testing, wherein the flexible cabled environment allows for flexible topological configurations and wherein the test environment provides a shielded test platform which will allow for close proximity testing of different wireless systems without interference.

### SUMMARY OF THE INVENTION

The present disclosure addresses the above-identified need by providing a system for simulating a wireless environment, including in one embodiment, a central RF combining component; a plurality of connection nodes, each connection node in RF connection with the central RF combining component through a programmable attenuation component; wherein the programmable attenuation components are controlled by a controller console, the controller console maintaining information regarding simulated spatial positioning of the plurality of connection nodes in the simulated wireless environment, and adjusting the programmable attenuation components to appropriately simulate the simulated spatial positioning of the connection nodes in the simulated wireless environment.

Additionally, an RF module for creating and receiving RF signals in a test environment is provided wherein the RF module includes a data network connection to transmit and receive data over a wired data packet network, at least one mounting surface, to connect a wireless network interface card, the mounting surface including connections so that a mounted wireless network interface card is in RF connection with a programmable attenuation component, wherein the programmable attenuation component is in RF connection with an RF port on the RF module; a controller, interfacing to the data network connection and including connections at the mounting surface, the controller to control a mounted wireless network interface card.

Furthermore, a test module, for simulating traffic in a wireless network is provided and includes a transceiver component, in RF connection with an RF port to the wireless network; a modulator/demodulator component, in communication with the transceiver component; a receive filter and distributor (RFD) component, in communication with the modulator/demodulator component, the RFD component to process data frames received from the wireless network; a transmit arbitrator component, in communication with the modulator/demodulator component, the transmit arbitrator component to process and transmit data frames to the wireless network; an access control unit, in communication with the RFD component and the transmit arbitrator component and at least one virtual client, the virtual client in communication with the RFD component, the transmit arbitrator component, and the access control unit, the virtual client maintaining state information regarding communications in the wireless network.

Also, a method of simulating traffic in a wireless network is provided wherein the method includes providing a modulator/demodulator component in communication with a transceiver component, the transceiver component transmitting and receiving in the wireless network; creating a plurality of virtual clients in connection with the modulator/demodulator, wherein the virtual clients transmit and receive data frames in the wireless network in compliance with a selected wireless communications standard, and wherein the virtual clients maintain individual state for communication protocol as required by the selected wireless communications standard.

An embodiment of the present invention is directed towards a system for isolating a device that uses a peripheral bus for data communication, including an RF isolation enclosure with an access door for insertion and removal of the device. It also includes a peripheral bus connector inside the RF isolation enclosure, to connect to the device; a peripheral bus signal path, connected to the peripheral bus connector, the peripheral bus signal path traversing from inside the RF isolation enclosure to outside of the RF isolation enclosure, the peripheral bus signal path to connect the device to a peripheral bus of a processor. The peripheral bus signal path includes RF filtering components to reduce undesired RF signals from entering or leaving the RF isolation enclosure on the peripheral bus signal path. The RF isolation enclosure can include an RF port, to provide an RF signal path from the device inside the RF isolation enclosure to outside the RF isolation enclosure.

A carrier card component is sized to fit within the RF isolation enclosure, the carrier card component including a device connector, to connect to a peripheral bus connection on the device, and a bus signal path from the device connector to a second connector, the second connector to connect to the peripheral bus connector inside the RF isolation enclosure. The carrier card component is removable from the RF isolation enclosure via the access door. When the carrier card component is inserted into the RF isolation enclosure, the second connector on the carrier card component connects to the peripheral bus connector inside the RF isolation enclosure. The carrier card component can include a device holding component to physically hold the device to the carrier card component.

The carrier card component can include an interface bridge component along the bus signal path between the device connector and the second connector, the interface bridge component to interface signals between the device and the peripheral bus. The present invention includes a plurality of different carrier card components, each carrier card component providing different bridge interface components for use with devices with different interfaces. An interface bridge component can interface signals between defined transmission protocols, some examples are PCMCIA, Cardbus, Universal Serial Bus (USB), IEEE 1394 (Firewire) and miniPCI.

The RF signal path from the RF connector to the device on the carrier card component can include an RF signal combiner to provide RF signals to a plurality of RF connections on the device. The RF signals at each RF connection on the device can be individually attenuated, to provide different RF signal strength to each of the plurality of RF connections on the device. Providing different RF signal strength to each of the plurality of RF connections on the device can test an antenna diversity feature of the device.

This embodiment can also include a data connector inside the RF isolation enclosure, to connect to the device, and a data signal path, connected to the data connector, the data signal path traversing from inside the RF isolation enclosure to outside of the RF isolation enclosure, the data signal path to connect the device to a data network external to the RF isolation enclosure.

The present invention also includes a method for attenuating undesired RF signals on a plurality of electrical signal paths. For each signal path, the method includes passing the signal path through a first filtering component, the first filtering component positioned within a first RF shielded chamber, then passing the signal path along a shielded signal path to a second filtering component, the second filtering component positioned within a second RF shielded chamber, the second RF shielded chamber separate from the first RF shielded chamber. The plurality of electrical signal paths can form a PCI bus.

An example method of use includes connecting the plurality of electrical signal paths to a data port on a device; placing the device within an RF isolation enclosure; and then for each one of the signal paths passing through the second filtering component, connecting to a second signal path passing from inside the RF isolation enclosure to outside of the RF isolation enclosure, to allow the device within the RF isolation enclosure to communicate with a processor outside of the RF isolation enclosure.

Thus method can also include mounting the filtering components and the RF shielded chambers on a flexible printed circuit board. Each of the second signal paths passing from inside the RF isolation enclosure to outside of the RF isolation enclosure can pass between shielded vias formed within the flexible printed circuit board. The shielded vias in conjunction with ground planes in the flexible printed circuit board form an RF shielded tunnel for each of the second signal paths.

Another feature of the present invention is directed towards the printed circuit board, that helps attenuate undesired RF signals on a plurality of electrical signal paths, for example on a PCI bus. The printed circuit board includes a plurality of signal paths, wherein each signal path passes through a first filtering component, the first filtering component positioned within a first RF shielded chamber, then each signal path passes through a shielded signal path to a second filtering component, the second filtering component positioned within a second RF shielded chamber, the second RF shielded chamber separate from the first RF shielded chamber. This provides a excellent level of RF signal isolation. The printed circuit board includes a flexible printed circuit board.

The printed circuit board can be used in conjunction with an RF isolation enclosure. The plurality of electrical signal paths are connected to a data port on a device that is placed within the RF isolation enclosure, and each of the signal paths passing through the second filtering component are connected to a second signal path that passes from inside the RF isolation enclosure to outside of the RF isolation enclosure, to allow the device placed within the RF isolation enclosure to communicate with a second device outside of the RF isolation enclosure.

Each of the second signal paths passing from inside the RF isolation enclosure to outside of the RF isolation enclosure passes between shielded vias formed within the flexible printed circuit board. The shielded vias in conjunction with ground planes in the flexible printed circuit board form an RF shielded tunnel for each of the second signal paths.

The present invention is also useful for testing a wireless device with a plurality of antenna ports. Such an embodiment includes an RF isolation enclosure, including an access door for insertion and removal of the device; a plurality of RF ports, to provide RF signal paths from each antenna port on the device inside the RF isolation enclosure to outside the RF isolation enclosure, wherein at least one of the RF signal path passes through an RF signal attenuation component. The RF signal attenuation component can be adjusted to provide a different RF signal strength at one of the plurality of antenna ports on the device. Providing a different RF signal strength at one of the plurality of antenna ports on the device test an antenna diversity feature of the wireless device. Also each RF signal path can connect to an RF switch to allow an external wireless device to be connected to a selected one of the plurality of antenna ports.

### BRIEF DESCRIPTION OF THE DRAWINGS

Referring to the exemplary drawings wherein like elements are numbered alike in the several Figures:

FIG. 1 shows a generalized overall test system environment;

FIG. 2 shows a simulated test system wireless environment;

FIG. 3 shows a simulated test system wireless environment having multiple test systems;

FIG. 4 shows a system chassis;

FIG. 5 shows a schematic diagram illustrating the layout and connections between a test system chassis and a backplane;

FIG. 6 shows a carrier module;

FIG. 7 shows a carrier module, in accordance with an alternative embodiment;

FIG. 8 shows an interference injector module;

FIG. 9 shows an inline channel simulator module;

FIG. 10 shows a generalized TestMAC device;

FIG. 11 shows a TestMAC device;

FIG. 12 shows a TestMAC device configured as a TestMAC module;

FIG. 13 shows a functional block diagram of an RF Port Module;

FIG. 14 shows a simplified schematic block diagram of an interconnection discovery device communicated with multiple test chassis;

FIG. 15 shows a functional block diagram of a first embodiment of a test system;

FIG. 16 shows a conceptual block diagram of a first embodiment of a test system;

FIG. 17 shows a functional block diagram of a second embodiment of a test system;

FIG. 18 shows a conceptual block diagram of a second embodiment of a test system;

FIG. 19 shows a functional block diagram of a third embodiment of a test system;

FIG. 20 shows a conceptual block diagram of a third embodiment of a test system;

FIG. 21 shows a carrier module configured to operate a single NIC and an inline channel simulator module;

FIG. 22 shows a block diagram illustrating a method of simulating traffic in a wireless network;

FIG. 23 shows a block diagram of computer's typical internal architecture for external communication;

FIG. 24 shows a block diagram of one method for shielding to prevent RF interference;

FIG. 25 shows a block diagram of another method for preventing RF interference;

FIG. 26 shows a perspective drawing of a carrier module in accordance with one embodiment of the present invention;

FIG. 27 shows a block diagram of a test chamber on the carrier module of FIG. 26;

FIG. 28 shows a block diagram of filter circuits for bus signal filtering according to one embodiment; and

FIG. 29 shows a mechanical drawing of a bus filter board according to one embodiment.

### DETAILED DESCRIPTION OF THE INVENTION

The exemplary embodiments of the test system and methods of operation disclosed herein are discussed in terms of a shielded test platform for close proximity testing of wireless systems under simulated operating conditions. However, it is contemplated that the test system may be utilized as a shielded test platform for various other applications, such as EMC/EMI compliance testing for both intentional and unintentional radiators. The following discussion includes a description of a plurality of possible test system configurations, followed by a description of the method of operating the test system in accordance with the present disclosure. Reference will now be made in detail to the exemplary embodiments of the disclosure, which are illustrated in the accompanying figures.

Currently, wireless systems are tested in an open air environment which does not permit easy reconfiguration of network topology or motion of the devices to enable roaming. As such, it will be appreciated that the test system is based on a system of RF signal combiners and programmable attenuators which are controllable via software to advantageously allow for the simulation of open air transmission. This may be accomplished by adjusting the programmable attenuators to simulate the transmission path loss normally experienced by wireless devices, thus yielding the ability to provide an accurate virtual positioning of devices under test (DUT).

As discussed herein, it is contemplated that multiple test systems may be operated in close proximity to each other by using one or more shielded enclosures to house the wireless devices. This advantageously prevents RF interference between test systems, thus allowing multiple test systems to be operated in the same lab, and even on the same lab bench. It is further contemplated that RF Isolation is also provided between wireless devices in the test system so that the signal level at the receiver inputs may be determined by the programmable attenuators and not by signal leakage. Additionally, it is contemplated that additional infrastructure may be included to provide a common synchronization capability, a control network, the ability to boot selectable OS images over the control network, and a network-attached control PC computer for test setup, orchestration and display of results.

For ease in understanding and because multiple test system configurations are contemplated, a generalized test system will be described followed by a description of each of the components, or possible components, of the test system. Once this has been completed, the preferred embodiments of the test system will be described.

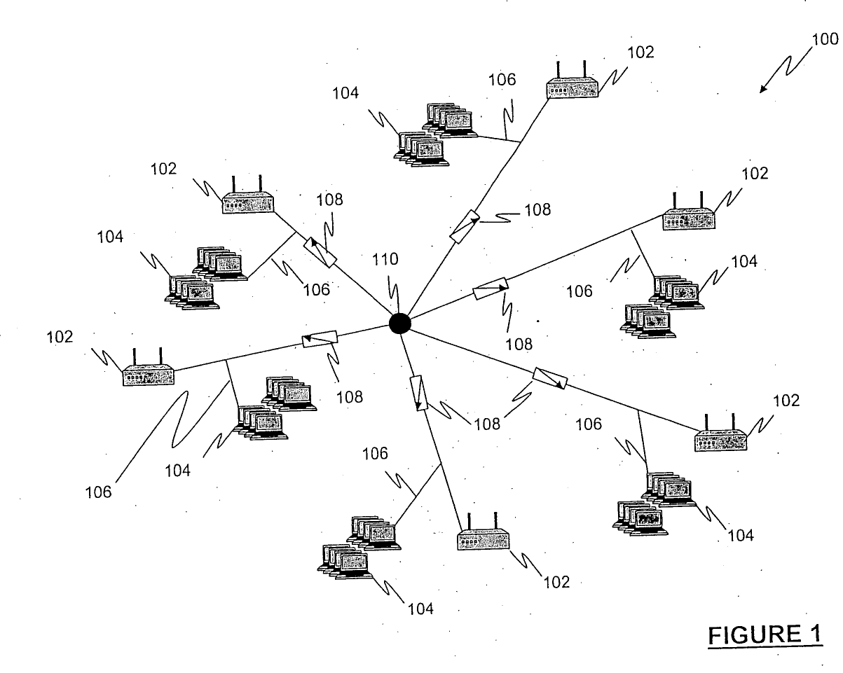

Referring to FIG. 1, a diagram showing a generalized overall view of a test system 100 wireless environment is provided and discussed. Typically, a plurality of Access Points (AP) 102 are provided, wherein each of the AP's 102 are connected to a varying number of associated wireless clients 104 by at least one signal path 106, wherein each of wireless clients 104 may be simultaneously operating on identical or independent frequencies in accordance with the wireless protocols as defined by the IEEE 802.11 standard. Additionally, as shown AP's 102 are connected together via at least one signal path 106 and because the signal path strength in an actual wireless environment may vary in strength due to various propagation factors, test system 100 allows for the simulation of the varying signal path strength via programmable attenuators 108. It is contemplated that programmable attenuators 108 are disposed in each path connected to the center hub 110 and are also used to connect each of the wireless devices to an RF combiner network. The RF combiner network advantageously provides for signal connectivity between all of the attached devices and programmable attenuators 108 advantageously provide the ability to adjust and set signal levels received at each wireless device receiver.

It will be appreciated that test system 100 may be configured in multiple ways such that every wireless device within test system 100 can ‘hear’ every other wireless device within test system 100, although not necessarily at the same time. Moreover, it will be appreciated that the signal path lengths for one or more of the wireless clients 104 may be lengthened or shortened (to simulate distance between the client device and AP 102) via the appropriate programmable attenuator 108, thus allowing for a ‘virtual positioning’ capability in order to simulate an actual wireless environment.

As referred to hereinabove, virtual positioning refers to the distance, or signal path length, between a wireless client 104 and an intended receiver/transmitter. The farther a client device is from an intended receiver/transmitter, the longer the signal path length and because signal degradation is directly related to the signal path length, the longer the signal path length, the more degradation the signal will experience. However, this relationship between signal degradation and signal path length advantageously allows for the simulation of variable signal path lengths via adjustment of programmable attenuators 108 disposed within the signal path 106. Thus, an increase or decrease in signal path length, in this case the positioning of a wireless client 104 relative to an RF combiner, may be simulated by changing the values of programmable attenuators 108 disposed within the signal path. Moreover, it is contemplated that virtual positioning of AP 102 may be simulated in this manner as well. It should be noted that one or all of the programmable attenuators 108 may be replaced with a signal processor in order to simulate other open air anomalies, such as signal distortion.

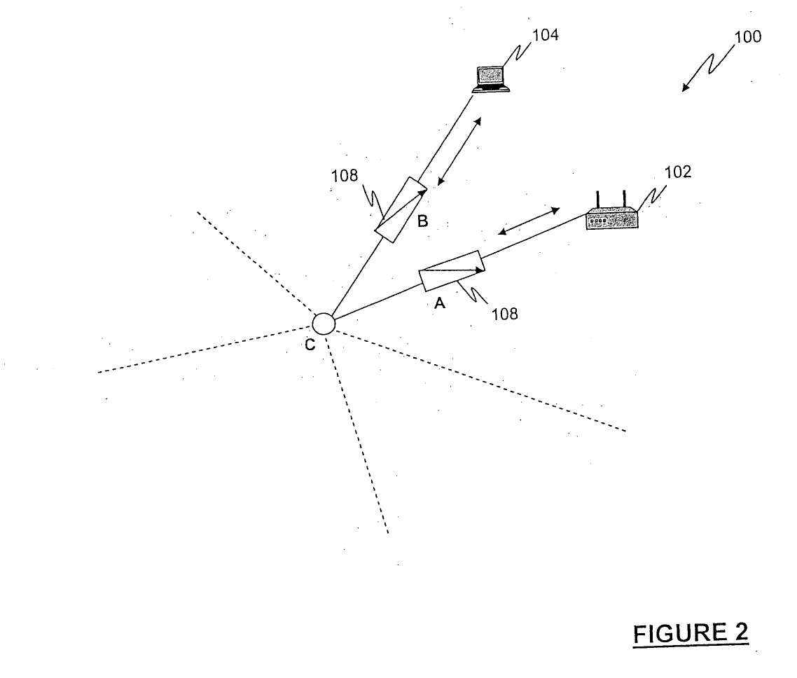

How virtual positioning is achieved will now be explained with reference to FIG. 2. As can be seen, a diagram of a simulated test system 100 wireless environment is shown and includes a wireless client 104 connected to a central hub via plurality of programmable attenuators 108, wherein the connection from each of the wireless clients 104 carries both the signals transmitted from and received at the particular wireless device. Consider an RF signal transmitted from AP 102 to wireless client 104. As can be seen, upon signal transmission from AP 102, the signal must pass through access point programmable attenuator A through an RF combiner C and through a client programmable attenuator B before being received at wireless client 104. The signal loss experienced by the path traversal may be determined and controlled by programmable attenuators A, B and the RF combiner C and may be adjusted to produce a predetermined received signal level of any desired value. It will be appreciated that, due to the reciprocal nature of the components, the same loss will be experienced by a signal transmitted by wireless client 104 to AP 102, provided the values of programmable attenuators A, B remain unchanged. It will be further appreciated that this is an accurate representation of the reciprocal nature of antennas, transmitters and receivers in a wireless environment.

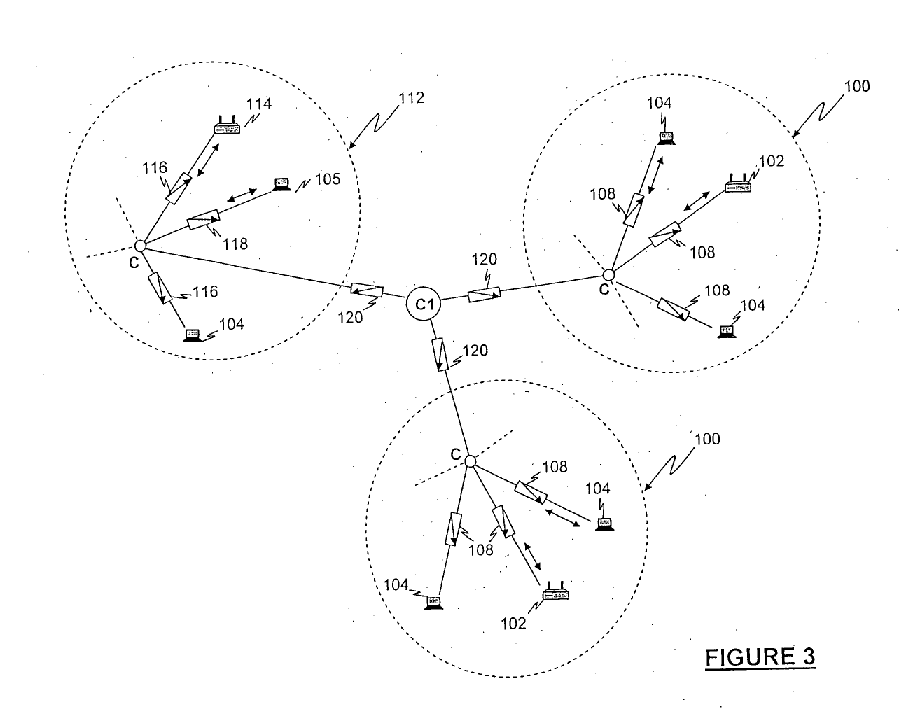

Thus, the loss introduced into the signal path by the test system 100 may be increased or decreased simply by adjusting the values of the applicable programmable attenuators 108 and because path loss in a wireless environment is roughly proportional to the physical spacing between the transmitter and receiver, the simulated position of wireless client 104 may be changed relative to AP 102 simply by changing the values of programmable attenuators 108. Moreover, it is contemplated that the concept of virtual positioning may be expanded by hierarchically extending test system 100. This is illustrated in FIG. 3 which shows several test systems 100 connected in a ‘star’ configuration, wherein an RF combiner hub C1 is disposed in the ‘center’ of the configuration and wherein each encircled test system 100 represents an individual wireless LAN system or Basic Service Set (BSS) composed of an AP 102 and an arbitrary number of wireless clients 104. Additionally, the RF combiner hub C1 connects to each of these test system 100 through programmable attenuators 108. In a similar manner as the system described in FIG. 2, each wireless LAN system may be ‘virtually positioned’ by changing the value of the appropriate programmable attenuator 108.

As such, it will be appreciated that test system 100 allows for the simulation of a variety of topology configurations and situations, such as simulation of coverage overlap which exists in real wireless LAN systems. For example, individual wireless LAN systems may be made to ‘overlap’ in their signal coverage by properly adjusting the values of the programmable attenuators connected to central RF combiner hub C1 in order to achieve the desired amount of signal overlap. This type of simulation may be achieved by setting the values of the programmable attenuators 120 relatively low to permit signals from one simulated wireless LAN 112 (a test system 100) to become detectable by the other test systems 100. Another example may be that a signal from a wireless client 105 may be made to appear stronger in the other test systems 100 than in the one to which it is directly attached. In fact, by increasing the value of programmable attenuators 116 on all other devices 104, 114 in its own test system 112 and decreasing the value of its own programmable attenuator 118 and the programmable attenuators 120 on central RF combiner hub C1, wireless client 114 will appear to have moved from one coverage area to another, thus simulating a roaming wireless client.

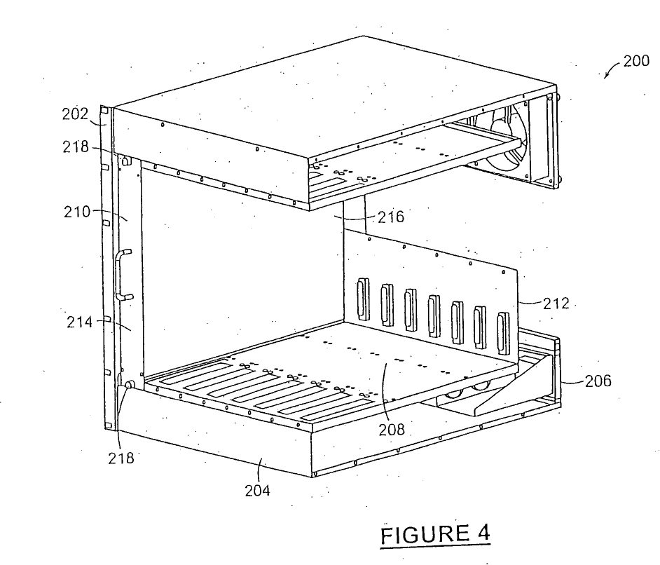

Referring to FIGS. 4-16, the components of test system 100 are shown and discussed. Turning now to FIG. 4, a system chassis 200 is shown and includes a chassis frame 202 having a front portion 204 and a rear portion 206, wherein system chassis 200 defines a chassis cavity 208 for containing, for instance, a Carrier Module (CM) 210 and a backplane 212. Backplane 212 is disposed within chassis cavity 208 such that backplane 212 is adjacent to and parallel with rear portion 206. It is contemplated that backplane 212 may be non-movably associated with rear portion 206 via any device and/or method suitable to the desired end purpose, such as screws, bolts and/or clips. CM 210 includes a CM front 214 and a CM rear 216 and is disposed within chassis cavity 208 such that CM rear 216 is adjacent to and communicated with backplane 212, as described in further detail hereinbelow. It is also contemplated that CM 210 may be non-movably disposed within chassis cavity 208 by mountingly associating CM front 214 with front portion 204 via a mounting device 218, wherein mounting device 218 may be screws, bolts and/or clips.

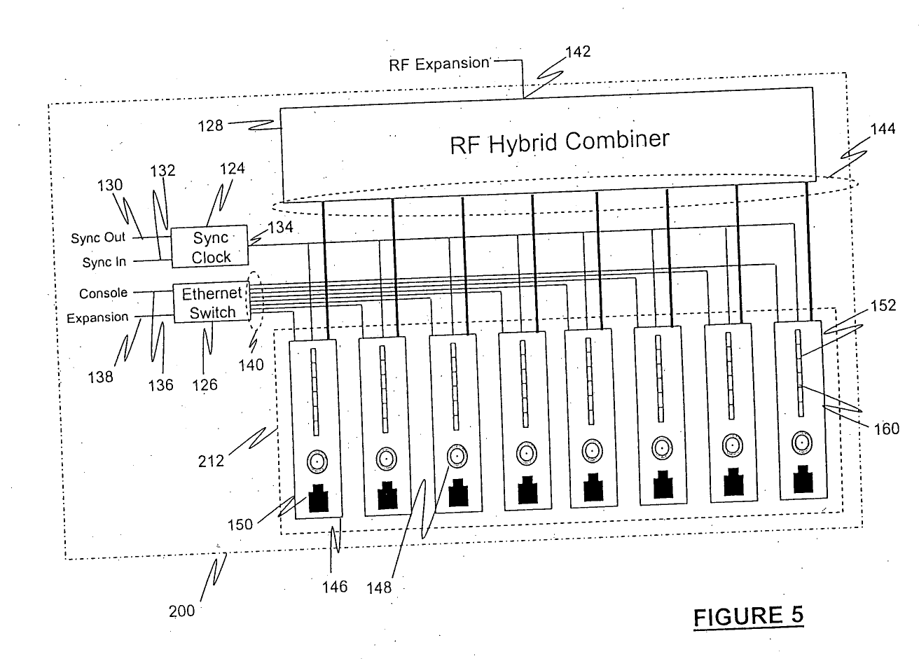

Referring to FIG. 5, a schematic diagram illustrating the layout and connections between system chassis 200 and backplane 212 is shown. System chassis 200 includes a Sync Clock (SC) 124, an Ethernet switch 126 and an RF combiner 128. SC 124 includes a Sync-Out port 130, a Sync-In port 132 and a Sync-Signal port 134. Ethernet switch 126 includes an Ethernet console port 136, an Ethernet expansion port 138 and a plurality of Ethernet communication ports 140. RF combiner 128 includes an RF expansion port 142 and a plurality of RF signal ports 144. Moreover, backplane 212 includes a plurality of module connectors 146, wherein each of the plurality of module connectors 146 includes a backplane RF port 148 communicated with at least one of the plurality of RF signal ports 144, a backplane Ethernet port 150 communicated with at least one of the plurality of Ethernet communication ports 140 and a backplane Sync-Signal port 152 communicated with Sync-Signal port 134. Additionally, a system power port may be disposed on rear panel and is preferably connected with a power distribution device disposed on backplane 212. The power distribution device is further connected with a plurality of power input ports 160 disposed on each of the module connectors 146 for power distribution to each of the system modules.

It is contemplated that rear portion 206 includes a plurality of connectors which provide an external communication capability with Sync-Out port 130, Sync-In port 132, Ethernet console port 136, Ethernet expansion port 138 and RF expansion port 142. It is further contemplated that each backplane RF port 148 is a blind mate connector which advantageously allows every system module to have an RF connection with RF combiner 128, and hence, the rest of test system 100. Additionally, it will be appreciated that the connection between each backplane Sync-Signal port 152 and Sync-Signal port 134 advantageously allows for the distribution of an identical sync signal to system module, thus allowing for multiple test systems to be synchronized as one.

Test system 100 includes a plurality of components or modules which may be required to simulate desired test environments. These components or modules include CM 210, an Interference Injector Module (IIM) 264, an Inline Channel Simulator Module (ICSM) 284, a TestMAC device 310, an RF Port Module (RFPM) 448, an Interconnection Discovery Device (IDD) 462, a Receive Filter and Distributor (RFD) 318, an Access Control Unit (ACU) 320, a Transmit Arbitrator (TA) 322, a Traffic Source/Sink (TSS) 328, an Interface Unit (IU) 326 and a Distributed Airlink Monitor (DAM). Each of these components or modules are discussed below.

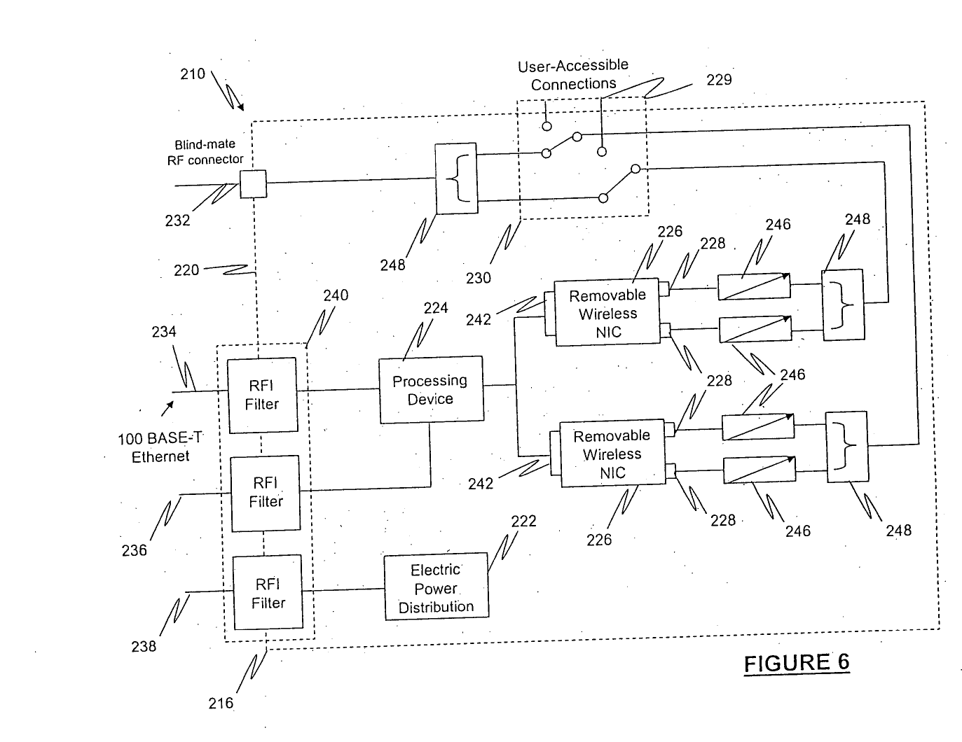

Turning now to FIG. 6, a block diagram of CM 210 is shown and includes a CM interface connector 220 disposed on CM rear 216, wherein CM interface connector 220 is sized, shaped and configured to easily and connectively interface with at least one of plurality of module connectors 146. CM 210 also includes a CM power distribution device 222 for distributing power to CM 210, a processing device 224, a plurality of wireless Network Interface Controllers (NIC's) 226, a plurality of diversity antenna ports 228 and a plurality of user-accessible connections 229 communicated with a plurality of RF switches 230. CM interface connector 220 includes a CM RF port 232, a CM Ethernet port 234, a CM Sync-Signal port 236 and a CM power port 238, wherein CM power port 238 and CM Ethernet port 234 and CM Sync-Signal port 236 are connected with CM power distribution device 222 and processing device 224, respectively, via a plurality of RFI filtering devices 240. Additionally, processing device 224 is communicated with plurality of NIC's 226 via NIC connectors 242, wherein plurality of NIC's 226 are further connected with CM RF port 232 via NIC diversity antenna ports 228, programmable RF attenuators 246, RF splitter/combiners 248 and plurality of RF switches 230. It will be appreciated that the embodiment of FIG. 6 advantageously allows for the ability to alternate between antennas as well as provides for a virtual positioning adjustment capability via programmable RF attenuators 246 disposed in the RF paths.

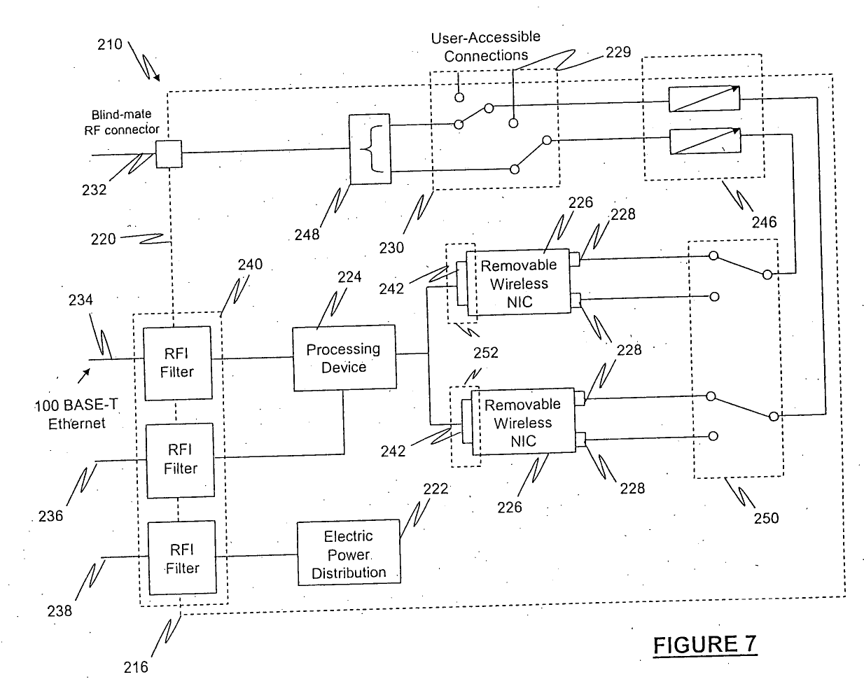

Referring to FIG. 7, a block diagram showing an alternative embodiment of CM 210 is shown and similarly includes a CM interface connector 220 disposed on CM rear 216, a CM power distribution device 222 for distributing power to CM 210, a processing device 224, a plurality of Network Interface Cards (NIC's) 226, a plurality of antenna ports 228 and a plurality of user-accessible connections 229 communicated with a plurality of RF switches 230. As above, CM interface connector 220 includes a CM RF port 232, a CM Ethernet port 234, a CM Sync-Signal port 236 and a CM power port 238, wherein CM power port 238 and CM Ethernet port 234 and CM Sync-Signal port 236 are connected with CM power distribution device 222 and processing device 224, respectively, via a plurality of RFI filtering devices 240. However, processing device 224 is communicated with plurality of NIC's 226 via NIC connectors 242, wherein plurality of NIC's 226 are further connected with CM RF port 232 via NIC diversity antenna ports 228, programmable RF attenuators 246, an RF splitter/combiner 248, RF switches 250, and RF switches 230. It will be appreciated that the alternative embodiment of FIG. 7 not only allows for the ability to alternate between antennas via a switch rather than via an attenuator, but also provides for a virtual positioning adjustment capability via programmable RF attenuators 246 disposed in the RF path. It should be noted that although only one Ethernet port is shown and described, it is contemplated that multiple Ethernet ports may be used

It will be appreciated that the primary wireless device in test system 100 is CM 210. It is contemplated that processing device 224 includes an operating system which supports a plurality of plug-in slots 252 for installing wireless LAN NICs 226, wherein the plurality of plug-in slots 252 may be either MiniPCI or PCMCIA connections. Each of the plurality of plug-in slots 252 include a slot diversity antenna port and a slot power port. It is contemplated that NIC's 226 include multiple antenna connections for diversity reception and that CM 210 provides connections to multiple antenna connections 228 through programmable RF attenuators 246, wherein RF switches 250 advantageously allow for diversity reception algorithms in NIC's 226 to be exercised while programmable RF attenuators 246 provide the primary adjustment capability needed to achieve the desired virtual positioning.

It will also be appreciated that user-accessible RF connections 229 advantageously provide for a direct connect capability to NIC's 226 by connecting directly into the RF paths and thus, bypassing RF splitter/combiner 248. It is contemplated that radio signals are communicated between NIC's 226 via CM RF port 232 and that CM Ethernet port 234 is a 100BASE-TX port which provides a control network interface to processing device 224. It is further contemplated that CM 210 may also include an additional 100BASE-TX Ethernet connection, which is connected to a front Ethernet port disposed on the front portion of CM 210 for carrying data traffic into and out of CM 210.

It will also be appreciated that CM 210 is preferably capable of supporting a plurality of operating system's (OS) and running a selection of OS images. This advantageously allows a user to operate a single or a plurality of wireless NIC(s) 226 under any OS for which an OS image exists, such as the Microsoft Windows® OS. It is contemplated that CM 210 obtains its OS image from the Boot Image Server (BIS) which, although is preferably operated on a control PC, may be operated using any PC connected to the control network. It will also be appreciated that the BIS acts in concert with a Boot Manager (BM) running on processing device 224 to load an OS image onto processing device 224. After the OS image is loaded, the BM causes processing device 224 to reboot into the new OS.

It is contemplated that software drivers may be provided for installing off-the-shelf NICs to advantageously allow for a test system capable of supporting volume-produced NIC's from various manufacturers for interoperability testing, development NIC's, and various software tools for configuring the wireless NIC's or for generating and/or analyzing network traffic Additionally, a wireless NIC 226 and software drivers may be supplied for installation into one or both plug-in slots 252 for recording all traffic on the airlink, wherein NIC 226 may have the ability to capture and record all traffic observed on a single radio channel for analysis and/or playback.

It will be appreciated that Interference Injector Module (IIM) 264 may be used to simulate a plurality of interference conditions and may be employed to provide different types of interference to test system 100. IIM 264 is capable of simulating a variety of different interference sources, such as microwave oven, RADAR, cordless phones or other communication systems operating in the same frequency band(s) as wireless NIC's 226. The inclusion of IIM 264 into test system 100 advantageously allows test system 100 to test wireless LAN equipment under a controlled interference environment using a predetermined type of interference in the radiation band of interest.

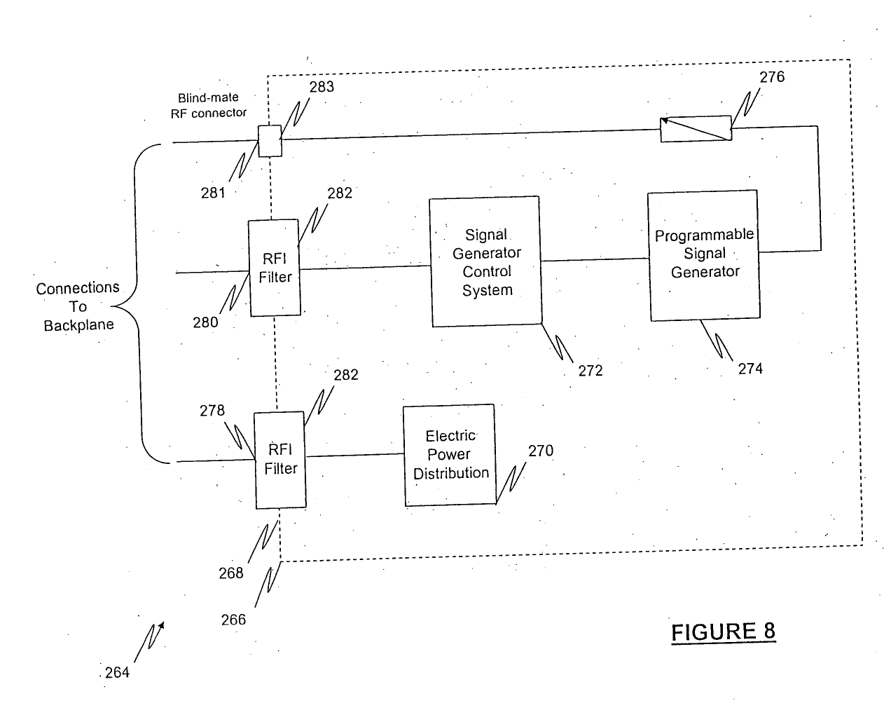

Turning now to FIG. 8, Interference Injector Module (IIM) 264 is shown and includes an IIM rear portion 266 having an IIM interface connector 268. IIM 264 also includes an IIM power distribution device 270, an IIM signal generator control system 272, an IIM programmable signal generator 274 and an IIM programmable attenuator 276. IIM interface connector 268 includes an IIM power port 278, an IIM Ethernet port 280 and an IIM RF port 281. IIM power port 278 is communicated with IIM power distribution device 270 via an RFI filter device 282. IIM Ethernet port 280 is communicated with IIM signal generator control system 272 via RFI filter device 282, wherein IIM signal generator control system 272 is further communicated with IIM programmable signal generator 274. IIM RF port 282 is communicated with IIM programmable attenuator 276 via a blind mate RF connector 283, wherein IIM programmable attenuator 276 is also communicated with IIM programmable signal generator 274. Moreover, IIM interface connector 268 is preferably sized, shaped and configured to easily and connectively interface with at least one of plurality of module connectors 146.

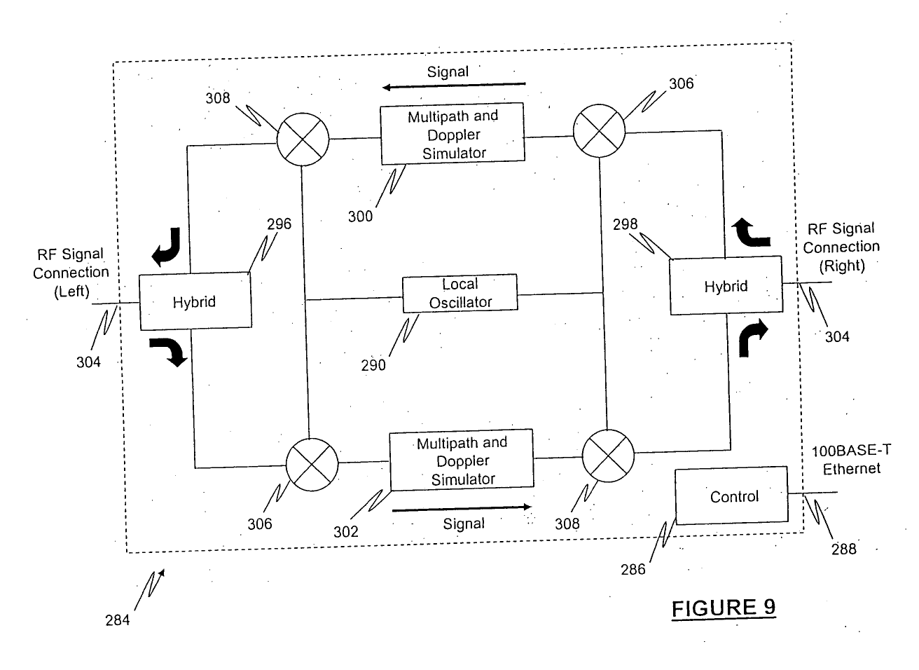

Referring to FIG. 9, an Inline Channel Simulator Module (ICSM) 284 is shown and preferably includes an ICSM control device 286 having an ICSM Ethernet port 288 and an ICSM local oscillation device 290. ICSM 284 also includes a first ICSM hybrid signal splitter/combiner 296 and a second ICSM hybrid signal splitter/combiner 298, each of which are communicated with a first Multi-path and Doppler simulator 300 and a second Multi-path and Doppler simulator 302. Additionally, first ICSM hybrid signal splitter/combiner 296 and second ICSM hybrid signal splitter/combiner 298 are communicated with an ICSM RF port 304.

It is contemplated that Inline Channel Simulator Module (ICSM) 284 may be employed to provide a means for simulating signal degradation typically caused by radio propagation phenomena common in wireless environments. It will be appreciated that the cabling in test system 100 carry a plurality of signals which are simultaneously transmitted, or carried, along both directions of the cabling. In order to apply the proper channel simulation to these signals, ICSM 284 separates the signals into a “left signal” and a “right signal” via first ICSM hybrid signal splitter/combiner 296 and second ICSM hybrid signal splitter/combiner 298, respectively. The “left signal” and “right signal” are then communicated to a down-converter device 306 which ‘down converts’ to a “left baseband signal” and a “right baseband signal” each having a baseband frequency. The “left baseband signal” and “right baseband signal” are then communicated to first Multi-path and Doppler simulator 300 and second Multi-path and Doppler simulator 302, respectively, where simulated channel signal distortion is applied. Once the signal distortion has been imposed upon the “left baseband signal” and the “right baseband signal”, the “left baseband signal” and the “right baseband signal” are then communicated to an up-converter device 308 which ‘up converts’ or restores the “left signal” and the “right signal” signal to its original radio frequency. Upon being ‘up converted’ the “left signal” and the “right signal” are communicated to ICSM RF port 304 via first ICSM hybrid signal splitter/combiner 296 and second ICSM hybrid signal splitter/combiner 298, respectively.

It will be appreciated that ICSM 284 is a digital signal processing implementation of a channel model as is known in the art and as can be found in the technical literature. It should be noted that test system 100 is wideband, i.e. it is not restricted to passing only the radio channels on which the wireless NICs' are approved to operate. Thus, it is contemplated that wireless devices operating on other than the IEEE 802.11 supported channels may be also be tested in test system 100. Thus, it is contemplated that a variety of general technical methods for simulating Multi-path and Doppler propagation effects may be used, all of which may be implemented using a digital signal processor. Additionally, it is contemplated that a specific tapped delay line model for simulating multipath distortion for wireless LAN systems may also be utilized.

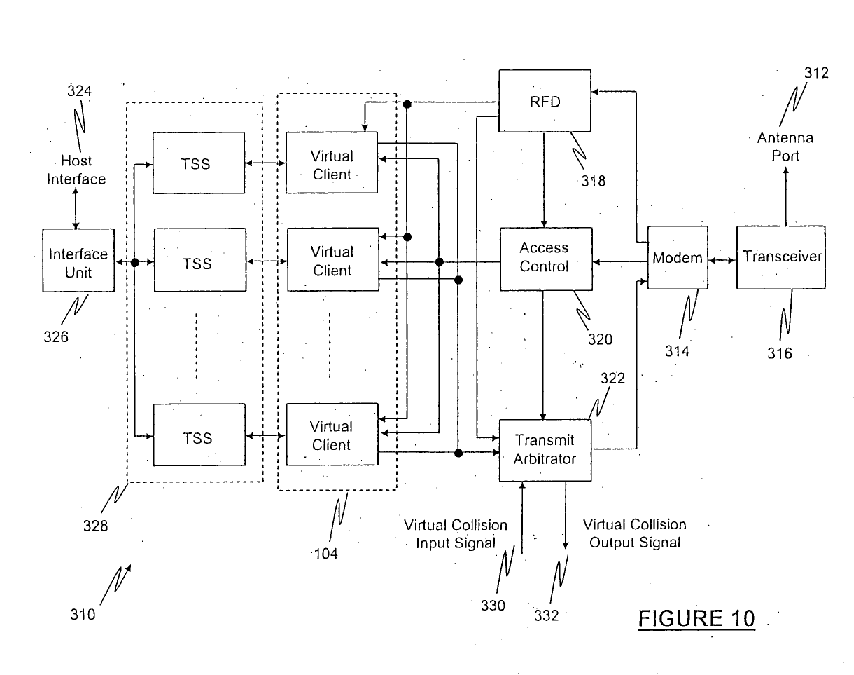

It will be appreciated that a novel part of the TestMAC device 310 relates to its ability to simulate an arbitrary number of wireless clients 104, or virtual clients, with realistic collisions. To create virtual clients 104, very specific modifications to the standard IEEE 802.11 MAC operation must be made and are described below. At a high level, the requirements on the TestMAC device 310 for creating virtual clients 104 are as follows: First, the TestMAC device 310 must send acknowledgement frames on receipt of directed data or management frames, if either of these frame types is addressed to a virtual client simulated by the TestMAC device 310 or a CTS frame on receipt of an RTS frame addressed to a virtual client simulated by the TestMAC device 310. Second, the TestMAC device 310 must provide transmit arbitration (simulation of contention) among all of the virtual clients 104 and use this arbitration to simulate airlink collisions. Third, the TestMAC device 310 must maintain the state of each individual virtual client 104 as if each were independent. This includes, but is not limited to, keeping each individual state in each virtual client 104 for reception of ACKs, retry counts, fragmentation and defragmentation, power save state and/or security parameters. The functions designed to meet these requirements are described as follows. Referring to FIG. 10, a function block diagram of a TestMAC device 310 configured to simulate virtual clients 104 is shown and discussed. The TestMAC device 310 typically includes a TestMAC antenna port 312 communicated with a TestMAC modem 314 via a TestMAC transceiver 316. TestMAC modem 314 is further communicated with a Receiver Filter and Distributer (RFD) 318, an Access Control Unit (ACU) 320 and a Transmit Arbitrator (TA) 322, wherein in TA 322 is communicated with both RFD 318 and ACU 320. Additionally, RFD 318, ACU 320 and TA 322 are further communicated with each virtual client 104, wherein each virtual client 104 is communicated with a host interface 324 via an interface unit 326 and a Traffic Source Sink (TSS) 328. TA 322 also includes a virtual collision signal input port 330 and a virtual collision signal output port 332.

Generally, RFD 318 advantageously processes the header of the received frames and causes an ACK or CTS frame to be transmitted, wherein an ACK frame must be transmitted in response to all frames received for the set of individual addresses TestMAC device 310 is intending to emulate and wherein a CTS frame must be transmitted whenever an RTS frame is received for an address in the set of individual addresses to be emulated by TestMAC device 310. If appropriate, RFD 318 also queues the received frame with the virtual client 104 to which it is addressed (this is the distribution function of RFD 318).

More specifically, upon receipt of a frame, RFD 318 verifies that the frame has a valid frame check sequence (FCS). The FCS is a value which may be computed from the contents of the entire frame, wherein a valid FCS indicates that it is extremely likely the frame was received without errors. RFD 318 then examines all the information in the MAC header of the received frame in order to determine whether the values for the header fields are consistent with the addresses in the frame. Both these operations are standard operations for a commodity IEEE 802.11 MAC.

Each frame includes a field called the Duration Field (DF) which specifies the length of time into the future that the transmitting station expects the airlink to be busy. This advantageously helps avoid the “hidden station” problem, which occurs when some wireless stations do not receive both sides of the transmission between two other stations. This is a typical feature of the IEEE 802.11 standard. RFD 318 determines whether the DF is valid, based on rules described in the IEEE 802.11 standard and, if appropriate, passes the value of the DF to ACU 320. RFD 318 then passes the destination address of the received frame to an address lookup function to determine if the destination address is that of a virtual client 104. If the destination address belongs to one of the virtual clients 104 TestMAC device 310 is emulating, RFD 318 determines whether the frame is one for which an ACK (or CTS) is required. It will be appreciated that under IEEE 802.11, all data and management frames whose destination field specifies an individual wireless client 104 must receive an acknowledgment frame. This is in contrast to addresses that specify a group of wireless clients 104 where frames so addressed are never acknowledged under IEEE 802.11.

It will be appreciated that the address matching function described above is unique to TestMAC device 310 because a standard commodity IEEE 802.11 device only needs to match against a single individual address before making the decision to ACK the frame. Moreover, it should be noted that the ACK decision is one which must happen extremely fast, for example, under IEEE 802.11(a) this can be as short as 2 μs. For this reason, the address matching operation may be distinguished from the matching operation required for frames with group addresses, which, since no ACK is required, do not need such a fast response. Thus, if RFD 318 determines an ACK is indeed required, RFD 318 informs TA 322. Additionally, RFD 318 also queues the frame in the receive queue of the appropriate virtual client 104. In the case of a received RTS frame whose destination address matches one of the virtual clients 104, RFD 318 informs the TA 322 that a CTS frame must be transmitted and indicates to the virtual client 104 that transmitted the RTS that the CTS frame was received.

It will be appreciated that ACU 320 is specialized to support virtual clients 104 and receives inputs from TestMAC modem 314, RFD 318 and TA 322. TestMAC modem 314 transmits a Clear Channel Assessment (CCA) signal and a Transmit Active (TA) signal, wherein the CCA signal indicates when TestMAC modem 314 is receiving a wireless LAN signal on antenna port 312, and wherein the TA signal indicates when the TestMAC modem 314 a wireless LAN signal on antenna port 312. RFD 318 transmits the value of the DF, which may update the Network Allocation Vector (NAV), as determined by the rules of the protocol, for dissemination to all virtual clients 104. It will be appreciated that this is novel and unique to test system 200 in that a common DF may be part of optimizations that allow the virtual clients to perform only processing unique to their instance. It is contemplated that TA 322 may also transmit a virtual CCA signal which indicates that one of the virtual clients 104 is transmitting (either directly, as e.g. a data frame, or indirectly, as an ACK or CTS frame) data. Each of these inputs affects the determination of whether the channel is busy. Moreover, ACU 320 provides timing information to TA 322 and provides channel status information to each of the virtual clients 104.

TA 322 then determines what frame is transmitted next via the airlink. TA 322 receives inputs from RFD 318, ACU 320 and from each virtual client 104. RFD 318 transmits a signal to indicate whether an ACK or CTS must be transmitted, along with the destination MAC address for these frames. ACU 320 transmits airlink timing information which enables the TA 322 to initiate frame transmissions at the correct time and virtual clients 104 transmit requests to send frames, wherein it is possible that two or more virtual clients 104 may attempt to send a frame simultaneously. There are two possibilities in this case. First, the airlink may already be busy, in which case all virtual clients 104 requesting to send frames must go into a “backoff” mode or second, the airlink may not already be busy in which case TA 322 determines that a virtual collision has occurred between the requesting virtual clients 104, wherein the response may be designed to simulate the effect of an actual airlink collision. TA 322 then transmits a grant signal to all requesting virtual clients 104 and determines which frame would take the longest time to transmit. TA 322 next generates random data to fill a frame to this length and transmits the frame to the TestMAC modem 314 for transmission, wherein the frame check sequence computed for this frame is deliberately made incorrect, thus guaranteeing that any receiving entity will discard the frame as an error.

Additionally, TA 322 transmits a logic signal, via virtual collision signal output port 332, to entities external to TestMAC device 3 10 indicating that a virtual collision has occurred. These external entities may be another TestMAC device, in which case the second TestMAC device receives the virtual collision signal via virtual collision signal input port 330. The effect of receiving the virtual collision signal is that TA 322 immediately schedules and transmits a random frame of a length no greater than that indicated with the virtual collision input signal. The intent is for two Test MAC devices 310 to transmit at very close to the same time, hence causing a real on-air collision of two simultaneous transmissions. If the second TestMAC is already busy transmitting a frame, then a collision is already certain, so there is no need to transmit a second frame.

It will be appreciated that where multiple TestMAC's may not be possible, real on-air collisions are still possible with the addition of a second transmitter dedicated to responding to the virtual collision output signal. This second transmitter would simply transmit random data of the appropriate duration to cause the real on-air collision. It will also be appreciated that users of TestMAC device 310 may prefer to have a collision which is not certain to be received in error. In that case, instead of sending random data, the actual desired data may be transmitted. If signals from two TestMAC devices 310 were to collide, the frame for one may be transmitted by the first TestMAC, with the other frame being transmitted by the second TestMAC. It is contemplated that this may be extended to more than two TestMACs.

Virtual clients 104 receives inputs from interface unit 326, RFD 318 and ACU 320. Each virtual client 104 is preferably assigned its own individual 48-bit station address, and implements the remaining functionality necessary to completely simulate a single IEEE 802.11 wireless client 104. This functionality may include, but is not limited to encryption and decryption, fragmentation and defragmentation and functionality of interest normally associated with the IEEE 802.11 MAC sublayer Management Entities, such as Power Management, Timing and Synchronization Function, Authentication and Association management, and channel scanning. It should be noted that interface unit 326 provides a connection with the host system and is preferably a bus-mastering PCI, miniPCI or Cardbus controller, as necessary for the hardware system in which the TestMAC is installed. Interface unit 326 may also be an interface to Ethernet, if appropriate in the system, without any loss of functionality.

As such, when virtual client 104 wants to transmit a frame, virtual client 104 checks the channel status indicator in ACU 320 in order to determine if the channel is free. If the channel is busy, several scenarios are possible. First, when the physical airlink has been clear for a DIFS period or longer, the virtual client 104 will attempt to send the frame to TA 322. Second, the physical airlink may be busy with a transmission from another physical device, in which case, a grant is denied. The virtual client 104 must then enter a “backoff” mode, wherein each virtual client 104 maintains its own “backoff” counter. Third, the airlink may be busy because one or more of the other virtual clients 104 is transmitting, wherein a grant to transmit is denied and virtual client 104 must enter into a ‘backoff’ mode, or fourth, two or more virtual clients 104 are attempting to access the channel at once. It is the job of TA 322 to detect this situation. RFD 318 provides the distribution function for frames sent to a particular virtual client 104, wherein data and management frames are queued based on the destination MAC address. Control frames or indications of a received control frame are also passed to the appropriate virtual client 104.

TSS 328 is provided in order to generate and analyze traffic. It is contemplated that TSS 328 may be implemented using any device and/or method suitable to the desired end purpose, such as software and/or hardware (ASIC, FPGA, firmware) As a traffic source, it may send traffic to one or more virtual clients 104 to which it is directly connected, or it may send traffic to the interface unit 326. In the former case, the frame will be passed to a virtual client 104 based on the source TestMAC device 310 address, wherein virtual client 104 may attempt to transmit it over the RF network. The frame is received by an AP device under test 102 through the RF network and relayed to the Ethernet-connected part of test system 100. It arrives at the host to which TestMAC device 310 is connected, is passed to interface unit 326 and received at TSS 328 from which it originated. This is known as egress traffic, wherein the traffic leaves a wireless network through AP 102. For ingress traffic, the traffic path is the reverse of the egress path. However, in both cases once frames arrive back at the TSS 328, various statistical measures are computed depending on the test that was being run. Moreover, TSS 328 may also act as a pass-through, allowing test frames to enter TestMAC device 310 from another source.

When hosted under a Windows® operating system, TSS 328 provides an Applications Programming Interface (API) to the operating system to allow each virtual client 104 to be accessed as if it were a separate network interface. This advantageously allows programs written for the Windows operating system to send and receive traffic over virtual clients 104. A further use of the API to each virtual client 104 is to allow packet bridging through the PC host to an Ethernet interface. This advantageously allows communication with the control network, or test traffic transmission and reception from the test network.

It will be appreciated that TestMAC device 310 may be employed to simulate a variety of operational conditions. TestMAC device 310 is preferably a programmable wireless transceiver capable of operating as a selectable number of standards-compliant wireless clients 104, as a system capable of violating existing Medium Access Control (MAC) protocols in controllable and predetermined ways or as a wireless AP 102. It is contemplated that TestMAC device 310 is also capable of recording and precise time-stamping of all signal traffic transmitted and received over the air for later playback and/or analysis. Moreover, although TestMAC device 310 is described and discussed herein as being used as a module in test system 100, TestMAC device 310 may be employed for field test purposes as a stand-alone component.

It will be appreciated that for testing an access point's ability to handle traffic from a service area, a single wireless station typically does not provide a realistic stress scenario. As such, TestMAC device 310 is capable of simulating a scenario where multiple wireless clients 104 are competing for access to the wireless network simultaneously. This capability advantageously eliminates the need to have multiple wireless clients 104, each attached to a computer, thus reducing the cost and space requirements. It will also be appreciated that ‘positive testing’, or testing of wireless NIC's 226 against another wireless NIC's 226 known to properly adhere to MAC protocol is typically not sufficient to fully exercise the operational capabilities of the wireless NIC's 226, as it can be seen that this type of testing ignores situations where MAC protocol is violated. As such, TestMAC device 310 advantageously allows for ‘negative testing’, in which deliberate violations of the MAC protocol are generated for the purpose of determining whether the wireless NIC's 226 under test are able to properly handle and ignore such violations and not become trapped in an undefined operational state.

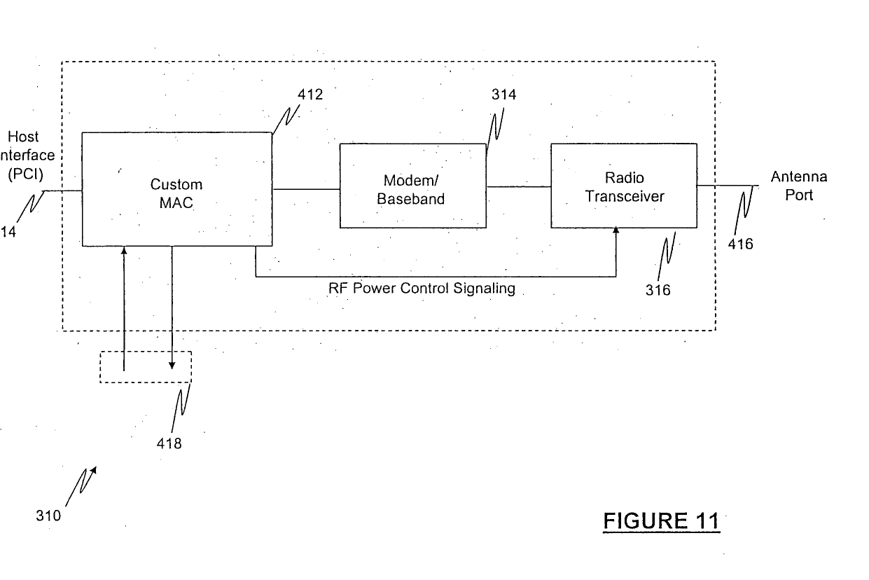

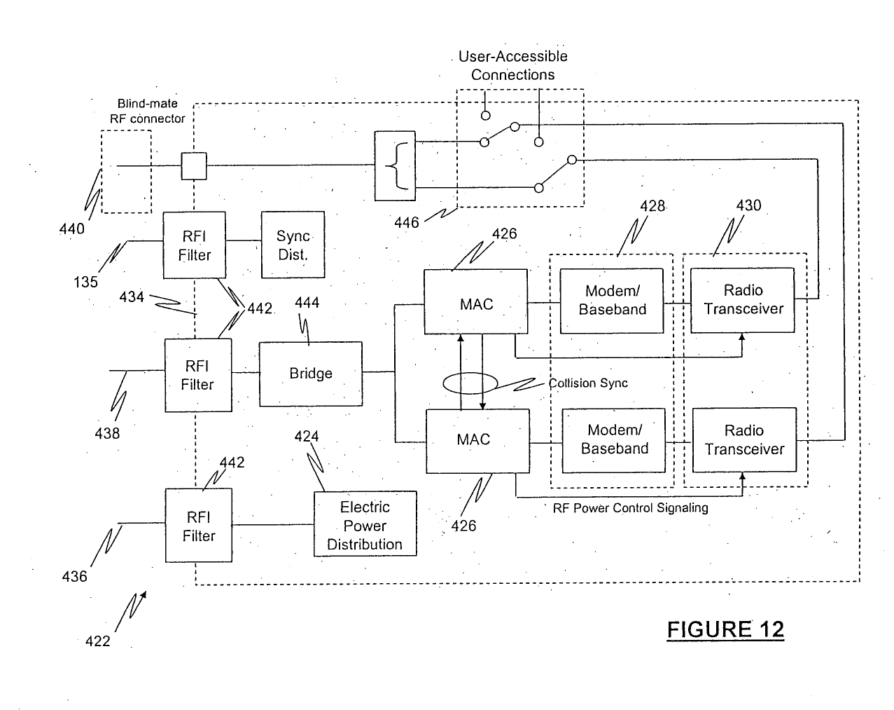

Referring to FIGS. 11 and 12, a functional block diagram of TestMAC device 310 and a functional block diagram of TestMAC device 310 being implemented as a TestMAC module 422, respectively, are shown and discussed hereinbelow. Additionally, it should be noted that although TestMAC device 310 is described herein as being implemented as a NIC version of TestMAC device 310 and as a TestMAC module 422, a module version of TestMAC device 310, it will be appreciated that TestMAC device 310 may be implemented in various other ways and is not meant to be limited to the description contained herein.

Turning now to FIG. 11, a functional block diagram of TestMAC device 310 being implemented as a NIC version of TestMAC 310 is shown and discussed. In this implementation, TestMAC device 310 includes a Custom MAC 412 communicated with TestMAC modem/baseband 314 which is further communicated with TestMAC Transceiver 316. Custom MAC 412 is designed to be plugged into plug-in slot 252 of CM 210, wherein plug-slot 252 is preferably a miniPCI plug-in slot. As such, TestMAC device 310 preferably includes a TestMAC miniPCI interface connector 414, a TestMAC antenna port 416 and a TestMAC collision sync input/output port 418, wherein TestMAC miniPCI interface connector 414 and TestMAC antenna port 416 connect to CM 210 in the usual way and wherein collision sync input/output signals are provided to test system 100 via TestMAC collision sync input/output port 418. The collision sync input/output signals required to simulate realistic collisions are described in more detail below. It is contemplated that when multiple TestMAC devices 310 are installed in CM 210, connections in CM 210 pass the signals between the multiple TestMAC devices 310. However, when regular wireless LAN NICs 226 are installed in CM 210, these connections in CM 210 are typically unused. It will be appreciated that alternative methods of communicating sync signals between multiple TestMAC devices 310 exist and include the use of messages communicated via the host interface.

Moreover, TestMAC device 310 includes a TestMAC programmable attenuator 420 connected in series with TestMAC diversity antenna ports 416, wherein TestMAC programmable attenuator 420 controls the RF power at which each signal frame is transmitted, thus allowing TestMAC device 310 to simulate the virtual position of multiple wireless clients 104. It will be appreciated that TestMAC device 310 advantageously includes the capability to control both signal transmit power and signal receive power thus providing virtual positioning for each Virtual Client (VC), whereas current off-the-shelf wireless LAN NICs only provide power adjustment capability for signal transmit power.

In another embodiment, multiple TestMAC devices 310 may be implemented in a single plug-in module for installation into test system 100. It will be appreciated that for this configuration Ethernet replaces the host PCI interface of TestMAC device 310. Moreover, collision sync signaling is provided directly without the need for a signal that leaves the module. Additionally, RF power control signaling is provided in the same manner as in TestMAC device 310 and both user-accessible and blind-mate backplane connections are provided for easy integration with test system 100.

Referring to FIG. 12, a functional block diagram of TestMAC module 422 is shown and discussed. TestMAC module 422 includes a TestMAC electric power distribution device 424, a plurality of Custom MAC devices 426, a plurality of TestMAC Modem/Baseband devices 428, a plurality of TestMAC radio transceivers 430 and a TestMAC rear portion having a TestMAC interface connector 434. TestMAC interface connector 434 includes a TestMAC power port 436, a TestMAC Ethernet port 438, a TestMAC Sync-Signal port 135 and a plurality of TestMAC RF ports 440, wherein TestMAC power port 436 is communicated with TestMAC electric power distribution device 424 via an RFI filter device 442. Additionally, TestMAC Ethernet port 438 is communicated with an RFI filter device 442 which is further communicated with each of the plurality of Custom MAC devices 426 via an Ethernet switch 444. It will be appreciated that multiple variations for implementing TestMAC module 422 are contemplated, for example one way might include utilizing Ethernet port 438 on TestMAC module 422, but not involve an Ethernet switch 444. Each of the plurality of Custom MAC devices 426 is communicated with one of the plurality of TestMAC Modem/Baseband devices 428, wherein each of the plurality of Custom MAC devices 426 and each of the plurality of TestMAC Modem/Baseband devices 428 are communicated with one of the plurality of TestMAC radio transceivers 430. Furthermore, each of the plurality of TestMAC radio transceivers 430 are communicated with at least one of the plurality of TestMAC RF ports 440 via user-accessible TestMAC RF connectors 446.

It will be appreciated that it is also possible to operate more than two Custom MAC devices 426 in the same TestMAC module 422 using a fairly straightforward process. The Ethernet interfaces from each Custom 802.11 MAC device 426 are simply multiplexed through TestMAC Ethernet port 438 and the RF connectors 446 are combined within TestMAC module 422 in order to reduce the number of RF ports to the two available on the backplane. Additionally, the collision sync signals are simply connected in a ring so that the output from one Custom MAC device 426 is connected to the input of the next Custom MAC device 426. This scheme allows for a sophisticated collision scenario among multiple Custom MAC devices 426, if desired. However, for the purpose of causing a collision between two radio entities, two Custom MAC devices 426 are sufficient.

The RF Port Module (RFPM) 448 is the key to expandability in test system 100. RFPM 448 may be installed in a single slot of the plurality of module connectors 146 and provide the means for flexible attachment of AP's 102 as Devices Under Test (DUT's) as well as additional test systems 100. A whole system chassis 200 may be filled with RFPM's 448 in order to provide for large-scale aggregation of wireless LAN systems for testing features that require coordinated operation of wireless LANs, such as roaming.

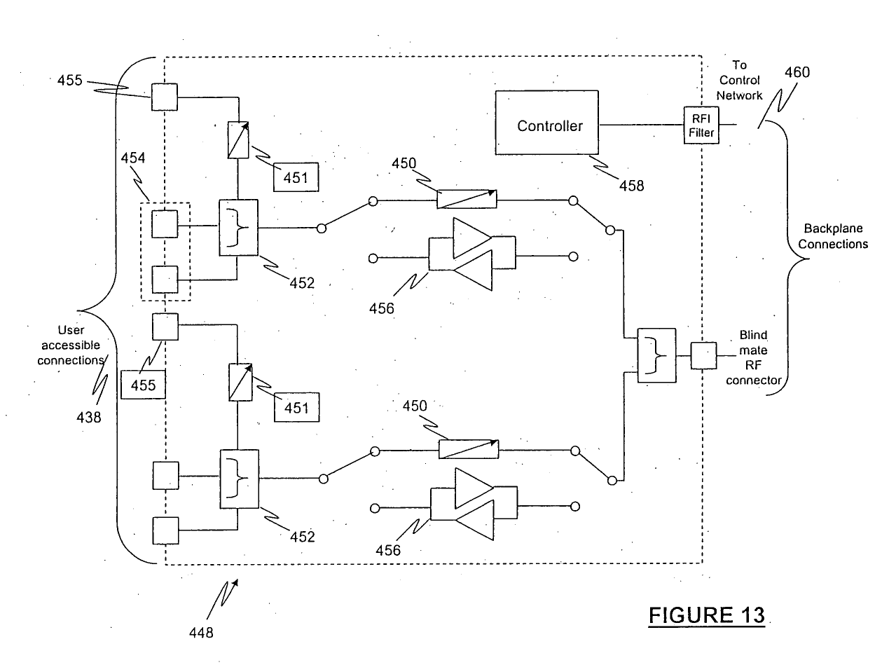

Referring to FIG. 13, an RFPM 448 is shown and includes a plurality of programmable attenuators 450 for precisely adjusting signal levels, power splitter/combiners 452 for providing expansion ports 454, and switch-selectable bidirectional amplifiers 456 to provide additional signal gain when a completely passive system is no longer scalable. It should be noted that power splitter/combiners 452 are further communicated with an RF test head connector 455 via programmable attenuators 451 to advantageously allow for multiple test heads to be connected to RFPM 448. Programmable attenuators 450, 451 may be adjusted and switch-selectable bidirectional amplifiers 456 may be selected via an onboard controller 458 which is attached to the system control network 460. It will be appreciated that RFPM 448 may support multiple independent channels of RF signals.

It will be appreciated that the test system 100 further includes a synchronization circuit disposed in system chassis 200 that provides a sync signal to each component within system chassis 200 and that are connected to backplane 212. This advantageously acts to resynchronize a counter internal to each system chassis 200 to a specific, high precision count value. Typically, the sync signal is provided to each component within system chassis 200 every 100 microseconds. However, it is contemplated that the sync signal may be provided to components within system chassis 200 at any timing rate suitable to the desired end purpose, such as every 100 nanoseconds. It is also contemplated that multiple system chassis's 200 may be employed and that a master sync signal may be provided to resynchronize counters internal to each system chassis 200. Master sync signal may be provided via a device that is externally and/or internally resident to system chassis 200.

Additionally, test system 100 includes a control network and a control processing device, wherein the control network is preferably a 100BASE-TX network which connects each test module to the control processing device and which provides control and coordination for all components in test system 100. It will be appreciated that the control network advantageously allows for the test and/or measurement data taken during a test procedure to be retrieved and communicated to the control processing device for processing. The control processing device is preferably a Personal Computer (PC) and is disposed external to test system 100 and includes the capability to configure, control and run all tests conducted by test system 100. A software application operating on the PC operates under the control of a user such that the user may select a test configuration, allow parameters to be entered and edited and, once the user is satisfied with the test, allows the user to configure various elements of test system 100 as well as to orchestrate the test. It is contemplated that this software application may also collect test and/or measurement data and communicate this data to the user is a predetermined and modifiable format.

It will further be appreciated that test system 100 will provide EM shielding which is sufficient such that multiple test systems 100 may be operated in close proximity with each other without experiencing test anomalies due to electromagnetic interference. This is clearly advantageous with IEEE 802.11(b) systems because they typically only have three channels available. For example, consider the testing of a roaming system under unshielded conditions (both unshielded test chassis and test cables). To conduct a roaming test properly, three channels are preferred (although it can be performed with two channels, three channels provides better results). However, if all three channels are being used by a single device under test using traditional over-the-air methods, other systems being operated nearby may induce electromagnetic interference into the test system. As such, no other systems may be operated (for any purpose) during the test. Thus, it will be appreciated that it is advantageous to not only shield each test system, but to shield each module contained within the system. This is necessary in order to provide sufficient electromagnetic isolation between multiple test systems as well as multiple test modules.

As an example of the importance of electromagnetic isolation, consider the antenna ports of two wireless NIC's 226. With a maximum transmitted RF power of 23 dBm and a minimum sensitivity of −82 dBm, the isolation between the antenna ports of wireless NICs 226 must exceed 105 dB on unintentional transmission paths (i.e., leakage). Without this isolation, it is possible that the minimum signal received by one of the wireless NIC's 226 may be determined not by the programmable attenuators, but by signal leakage. This is undesirable because receiver input levels must be settable through programmable attenuators for the virtual positioning capability to work over the entire intended range. It will be appreciated that there are multiple types of RF isolation: isolation regarding individual system isolation (i.e. isolation from the outside world) and isolation regarding test system to test system. The former is necessary to avoid outside interference and to enable test systems to work side by side. The latter is necessary to enable accurate virtual positioning.

It is contemplated that test system 100 may be configured in a variety of ways, using one or more test chassis's 200 to construct the desired wireless topology. To take full advantage of the test environment, a topology system map must be generated within the system software to represent the topology as constructed, in a process referred to as “system discovery.” Unfortunately, however, a manual system discovery process is time consuming and prone to errors. Thus, it would be advantageous for the system discovery process to be performed automatically. The system discovery process includes determining the contents of any single chassis 200 and the connections between multiple chassis's 200. It will be appreciated that determining the contents of any single chassis 200 is relatively simple because the means for identifying installed modules has been designed into the system in the standard way. However, determination of the RF cabling connections between multiple chassis's 200 is a much more open-ended problem because of the flexibility the user has in connecting the cables.

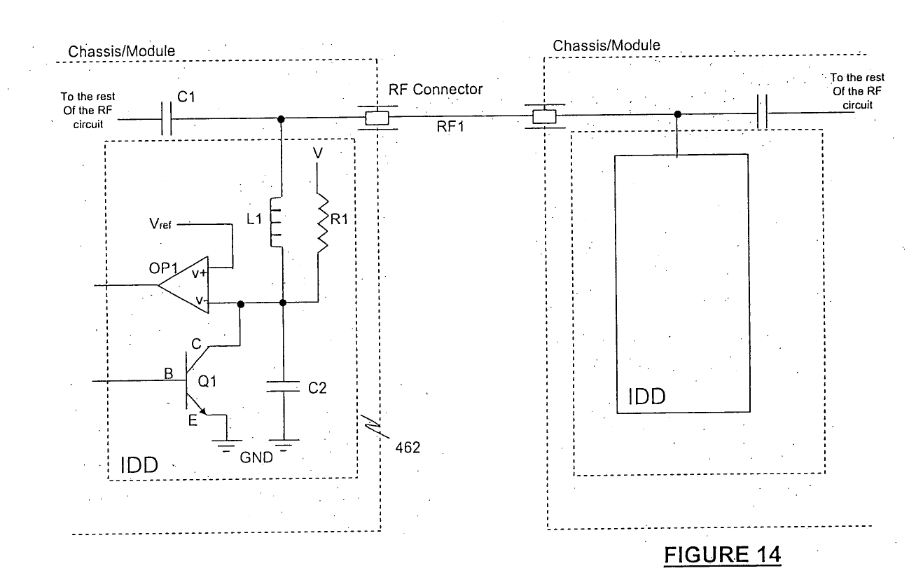

In order to simplify this process, test system 100 may include an interconnection discovery method and an Interconnection Discovery Device (IDD) 462 for RF interconnection discovery. IDD 462, used in conjunction with the interconnection discovery method, advantageously and unambiguously maps all the RF connections to test system 100. FIG. 14 depicts a simplified schematic block diagram of multiple test chassis's 200 and an IDD 462. The left side of the diagram shows a single RF port 464 on a test chassis 200 or module. The right side shows a similar test chassis 200 or module with the same type of IDD 462. They are connected by an RF transmission line RF1, typically a shielded coaxial cable. The idea is to allow sensing the presence of a small current flowing between any RF ports 464 on one or more chassis 200, thereby indicating the presence of the cable. By turning the current on and off, software running in the console can determine which two ports are connected.

Referring to FIG. 14, an IDD 462 is shown and includes RF transmission line RF1, a capacitor C1, a capacitor C2, an inductor L1, a resistor R1, a transistor Q1 and a comparator OP1 having a comparator output Vo, a positive input V+ and a negative input V−. Capacitor C1 is preferably a DC blocking capacitor which is disposed in series connection with RF transmission line RF1 in order to provide isolation between IDD 462 and the RF components inside test chassis 200 or the test modules. This advantageously allows RF signals at the frequencies of interest to pass, but filters out any DC component on RF1. Inductor L1 is connected between RF1 and negative input V− of comparator OP1 and provides an RF impedance sufficient to minimize the RF insertion loss caused by the insertion of IDD 462 into test system 100, but which allows DC signals to pass. Resistor R1 is connected between negative input V− of comparator OP1 and a positive voltage source V and provides a DC bias to IDD 462, which is conducted to the far end of any RF cable attached to an RF port. Capacitor C2 is connected between negative input V− of comparator OP 1 and a system ground GND and provide a path to ground for any RF signal leaking past inductor L1. This advantageously keeps the RF signal from leaking onto the DC power supply.

Transistor Q1 is preferably an NPN transistor having an emitter E, a collector C and a Base B, wherein E is connected to system ground GND and C is connected to negative input V− of comparator OP1. Positive input V+ of OP1 is connected with a reference voltage source Vref which is set to approximately one half of the voltage of positive voltage source V. When Base B is forward biased, transistor Q1 brings the RF signal conductor close to system ground potential GND and comparator OP1, sensing the drop in voltage, changes its output state at Vo. This drives a logic level within interface circuitry that passes the state change at Vo on to the console program.

It will be appreciated that this is not the only possible embodiment of the IDD 462. For example, by exchanging Q1 and R1, and making Q1 a PNP transistor, the RF conductor is at ground potential unless the transistor is turned on. This simply inverts the logic required to detect the cable presence. It should also be noted that transistor Q1 may be part of a logic gate. Such gates are known as having an open collector output which would be very suitable for IDD 462. In addition, other types of transistors or switching devices are also possible. For instance, a MOSFET or FET may be substituted or a mechanical switch could also be used.

It will be appreciated that the IDD 462 may be attached to every RF port and may be configured to receive or transmit a signal. However, under normal operating conditions IDD 462 is configured to receive signals, wherein IDD 462 may be operated as follows. When test system 100 needs to update the system map, a control program running on the console system begins stepping through every RF port, activating each IDD 462. If the activated RF port is connected to another RF port, the IDD 462 on the remote port will detect a current flow. Because there is only a single other RF port activated in the system, this establishes that there is a connection between the two RF ports. The control program then deactivates the IDD 462 in the current RF port and moves on to other RF ports in the system that have yet to be tested, thereby establishing the external RF connectivity of all devices.

It will be appreciated that in many test situations, it is desirable to be able to record all traffic observed on the airlink for analysis and playback. For example, consider the closely-related activities of compliance and interoperability testing. Compliance testing involves verifying that a single wireless device adheres to a standard, whereas interoperability testing determines whether two or more wireless devices can work together properly. To gain the most from such testing, an ability to monitor the actual airlink traffic is necessary and advantageous. Thus, it is contemplated that a vendor-supplied wireless NIC may be used as an Distributed Airlink Monitor (DAM). It is also contemplated that one or multiple DAM's may be employed to monitor and/or record a single or multiple channels depending upon the test requirements. This monitor NIC preferably includes the ability to capture and record all traffic observed on a single radio channel for later playback and analysis. The monitor NIC also includes features such as one might find in a traditional logic analyzer or network packet capture software, such as time stamping, triggering on an event, traffic filtering, etc. This advantageously enables complex airlink scenarios to be debugged, including rate adaptation, security transactions, QoS negotiations and delivery of service, as well as many other situations. It should be further stated that the DAM may be composed of a plurality of wireless NIC's (i.e. monitor NICs) disposed throughout test system 100, and may include analysis software resident within test system 100 or any other suitable location (e.g. console) that collects and processes all information gathered by the monitor NICs.

It will be appreciated that this type of configuration may be useful when a test system is configured to simulate several BSS's, such as discussed hereinbelow. A monitor NIC is preferably installed in each test chassis 200 and programmed to monitor the channel on which the AP 102 is operating. Because the monitor NIC does not transmit, there is no possibility that the monitor NIC will overdrive other devices with a strong signal. Hence, the programmable attenuator within CM 210 can be set to provide a generous signal level from all wireless devices 104 in the BSS. The key in this scenario is to set the attenuator so the monitor NIC may receive signals from stations disposed far away at the maximum data rate, while also preventing signal overloading from the wireless device 104 under test in the same CM 210. The synchronization infrastructure built into the test system 200 may also allow for global timestamps to be assigned to each frame received by the monitor NIC and with monitor NICs assigned to each channel operating in the test system 100, complex roaming scenarios may advantageously be simulated and analyzed.

It will be appreciated that a user-selected wireless NIC may be installed in one slot 252 of the CM 210 as a device under test (DUT) NIC and a vendor-supplied wireless NIC may be installed in the other slot 252 as a monitor NIC. In this configuration, the monitor NIC receives a sufficient amount of signal power from the DUT NIC so that all frames transmitted by the DUT NIC may be correctly received at the monitor. It should be noted that for some settings of the programmable attenuators it may be possible that not all frames received at the DUT will be successfully received by the monitor NIC. However, with a monitor NIC present next to every DUT NIC, it may be possible to collect and collate traffic data from each monitor NIC and recreate the entire airlink transaction. Additionally, the global timestamp capability advantageously allows a timestamp to be assigned to each frame received by the monitor NIC, thus giving the distributed monitoring system an omniscient view of a wireless LAN. This omniscient viewpoint will advantageously allow for true collision detection to occur.

Typically, the only information one has when a collision occurs is that a frame was received in error. If two or more DUT NICs transmit at the same time, the monitor NIC is almost guaranteed to receive the DUT signal in spite of the collision because it is so strong at the monitor NIC and the timestamp on each received frame will show that both frames were transmitted at the same time, hence proving a collision occurred. It is contemplated that the distributed monitoring system may also detect hidden stations. This may be accomplished by noting that one or more DUT NICs do not “hear” another DUT NIC simulated to be further away. This is helpful both for removing such situations from a test configuration, if it is not desired, and for making sure a DUT introduced as a hidden station for test purposes is in fact a hidden station.

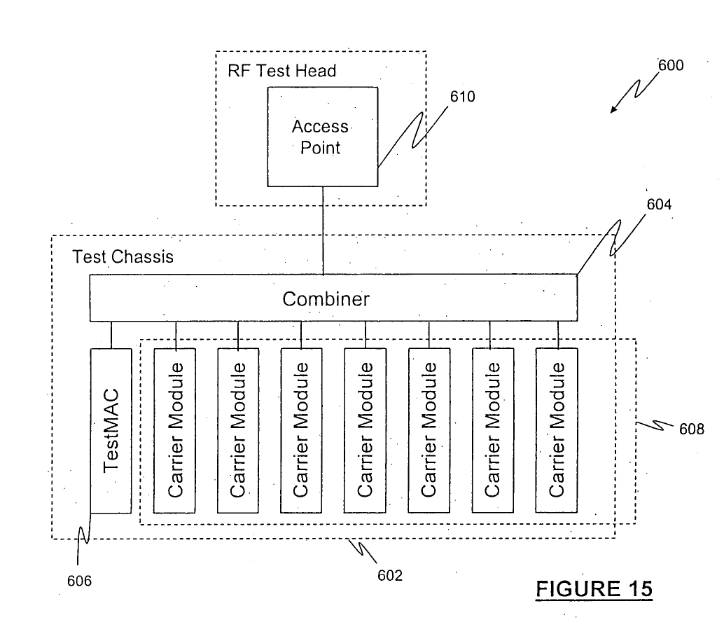

Turning now to FIGS. 15-20, multiple configurations of test system 100 are shown and discussed. It will be appreciated that the test system configurations discussed below are not intended to represent all of the possible test system configurations and thus is not intended to limit the possible configurations to those discussed herein.

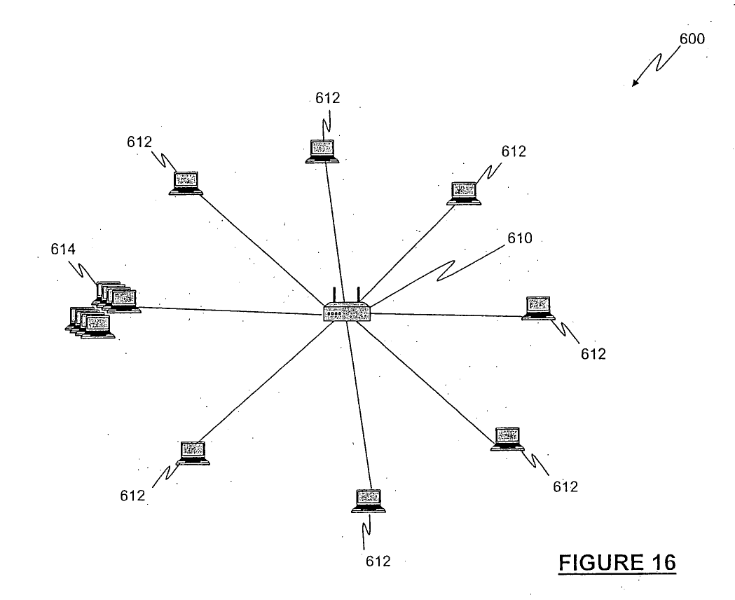

Referring to FIG. 15 and FIG. 16, a functional block diagram and a conceptual block diagram of a first embodiment of a test system 600 are shown, respectively. Test system 600 includes a test chassis 602 having an RF combiner 604, a TestMAC module 606 and a plurality of CM's 608, wherein TestMAC module 606 and plurality of CM's 608 are communicated with RF combiner 604. RF combiner 604 is communicated with an access point 610 which is further communicated with a plurality of wireless clients 612. It will be appreciated that, in this configuration, there are shown seven CM's 608 and seven wireless clients 612, wherein each of the seven CM's 608 is associated with only one of the seven wireless clients 612 and that each CM 608 is only half populated by wireless NICs in order to simplify the explanation.

Additionally, referring to FIG. 16, a ‘group’ of multiple wireless clients 614 are shown as being representative of TestMAC module 606, wherein TestMAC module 606 is configured as a TestMAC module 606, 422. As previously discussed, TestMAC module 606 may be configured to represent a predetermined number of wireless clients 612. It can be seen that the connection to RF combiner 604 and access point 610 is provided through test chassis 602.

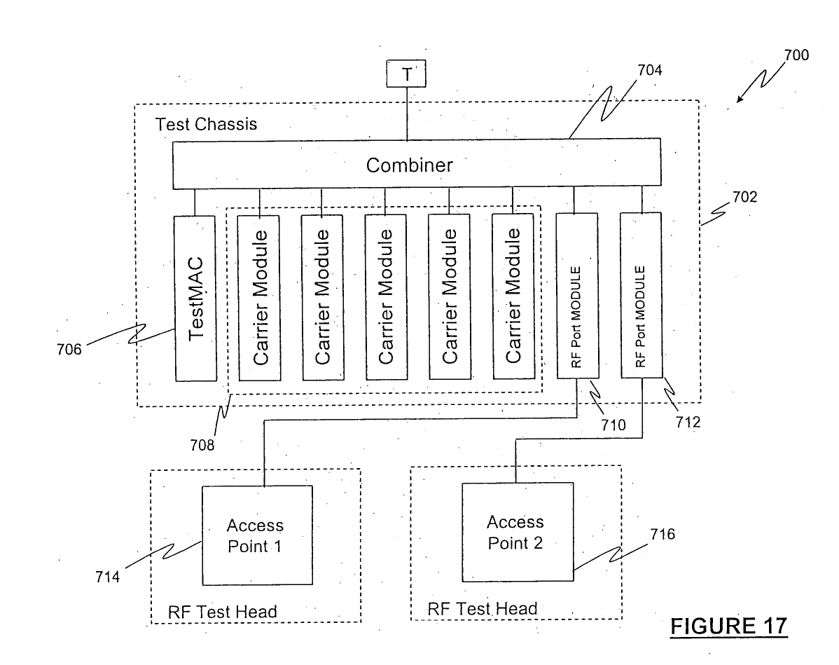

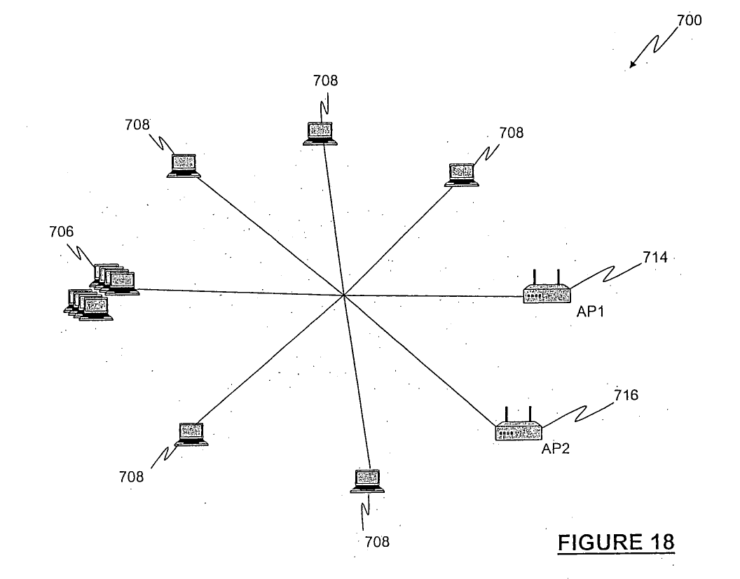

Referring to FIG. 17 and FIG. 18, a functional block diagram and a conceptual block diagram of a second embodiment of a test system 700 are shown, respectively. Test system 700 includes a test chassis 702 having an RF combiner 704, a TestMAC module 706, a plurality of CM's 708, a first RFPM 710 and a second RFPM 712, wherein TestMAC module 706, plurality of CM's 708 and first and second RFPM′ 710, 712 are communicated with RF combiner 704. Test system 700 also includes a first access point 714 communicated with first RFPM 710 and a second access point 716 communicated with second RFPM 712. It will be appreciated that first access point 714 and second access point 716 are connected to first RFPM 710 and second RFPM 712, respectively, through the RF test head connector 455.

It will be appreciated that this configuration advantageously permits a simple roaming scenario to be tested in which the wireless NICS, having first been associated with first access point 714 are all caused to roam to second access point 716. This may be accomplished by first setting the programmable attenuators so that the reception between first access point 714 and the wireless NICs is most favorable, then changing the attenuators in the access point paths so that reception with second access point 716 also becomes most favorable. A similar test may be performed in which second access point 716 is powered on shortly before first access point 714 is powered off. This will advantageously cause a ‘mass migration’ of clients to second access point 716, the effect of which will cause significant stress levels on the mechanisms within second access point 716 that handle the IEEE 802.11 association process.

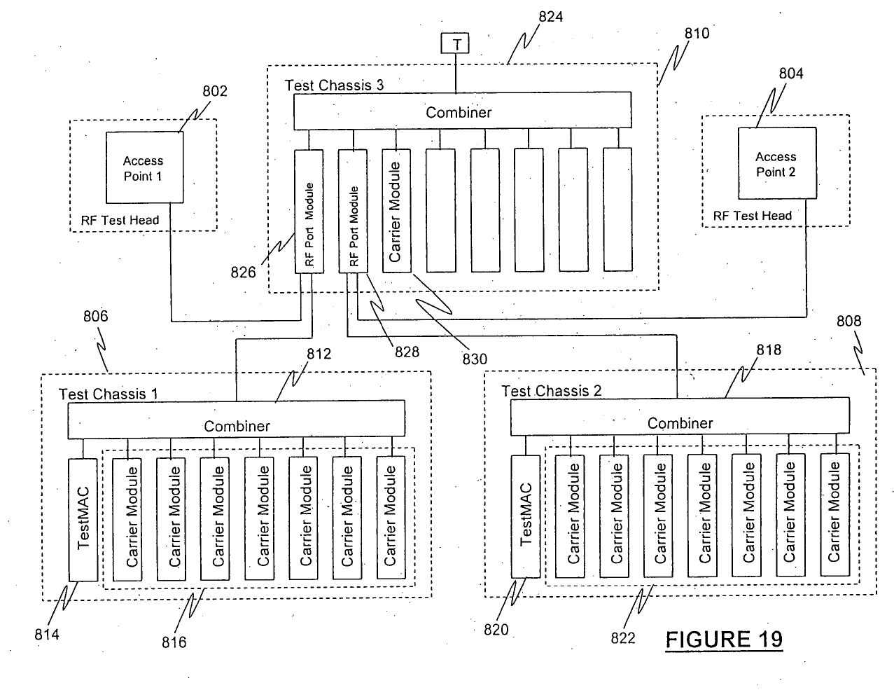

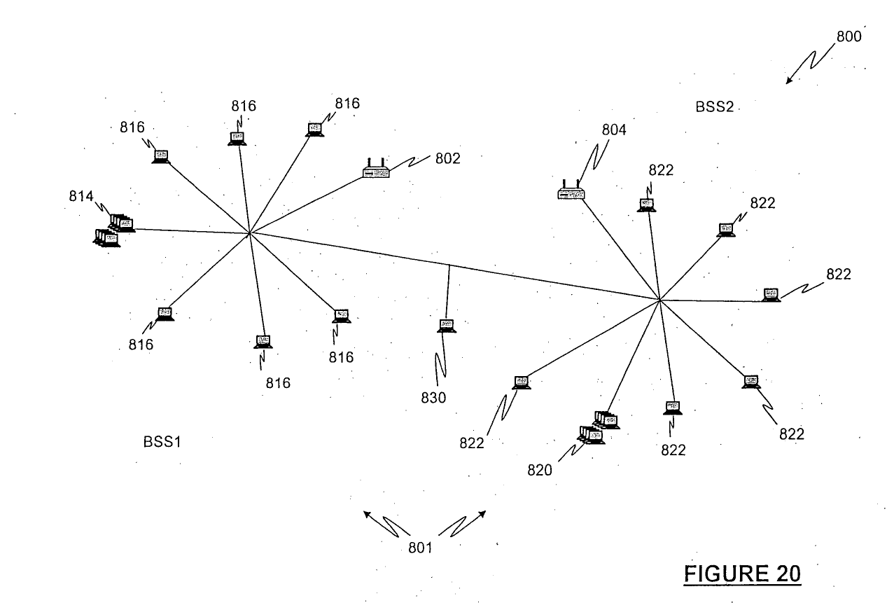

Referring to FIG. 19 and FIG. 20, a functional block diagram and a conceptual block diagram of a third embodiment of a test system 800 are shown, respectively and depicts two Basic Service Sets (BSS) 801, each of which includes a wireless access point 102 and a plurality of wireless clients 104. Test system 800 includes a first access point 802, a second access point 804, a first test chassis 806, a second test chassis 808 and a third test chassis 810, wherein first test chassis 806, second test chassis 808 and third test chassis 810 are connected in a hierarchical manner and wherein first test chassis 806 and second test chassis 808 represent the two BSS's 801.

First test chassis 806 includes a first RF combiner 812 communicated with a first TestMAC module 814 and a plurality of first CM's 816, second test chassis 808 includes a second RF combiner 818 communicated with a second TestMAC module 820 and a plurality of second CM's 822 and third test chassis 810 includes a third RF combiner 824 communicated with a first RFPM 826, a second RFPM 828 and a third CM 830. It should be noted that first RFPM 826 and second RFPM 828 are being utilized as RF expansion modules and are connected to third test chassis 810 via the RF expansion port on each RFPM 826. It is contemplated that the connection between the two BSS's 801 allows stations in one BSS 801 to potentially receives the stations in the other BSS 801. It is further contemplated that the wireless client 830 in FIG. 18 is one that may be associated with either BSS 801, depending on its virtual position. It is further contemplated that first access point 802 is connected to a first AP test head 832 via RF test head connector 455 on first RFPM 826 and that second access point 804 is connected to a second AP test head 834 via RF test head connector 455 on second RFPM 828.

Third CM 830 includes a single client NIC which is preferably configured to simulate a roaming wireless client, as shown in FIG. 15. It will be appreciated that by adjusting the programmable attenuators in the RFPM's 826, 828 the single client NIC can be made to ‘hear’ one access point better than the remaining access point, and hence exercise the wireless client's roaming algorithms. It will be appreciated that while only a single NIC is described as being utilized in third test chassis 810, multiple NIC may be used, each with the same roaming abilities. Thus, using the programmable attenuators in the RFPM's 826, 828 and those provided in the first, second and third CM's 816, 822, 830, a wide variety of roaming scenarios may be simulated using the NIC's in third test chassis 810.

It will be appreciated that when a radio signal is transmitted, the signal typically experiences reflection, diffraction and absorption due to objects disposed in the environment. Additionally, wireless devices may also include directional antennas which further influence the transmitted signals and relative motion between the transmitter and receiver, or motion of objects in the environment, may introduce Doppler shifts on the propagating signal as well. Thus, the overall effect of the environment on a radio signal may be grouped into two parts: path loss and distortion. Path loss represents a gross decrease in the received level of the radio signal from the level that was transmitted and is typically a function of the distance between the transmitter and the receiver, signal absorption through intervening obstacles, and the gain of any antennas in the direction of the direct ray.

Distortion effects are typically caused by multipath and by Doppler shifts. Multipath distortion is caused when reflected waves are received with a multitude of phases and amplitudes and summed by the receiver circuitry. Thus, the fact that some waves are in phase (reinforcing components of the direct signal ray) and some waves are out of phase (canceling components of the direct signal ray) may cause extreme signal distortion. As such, a particular reflected ray is in or out of phase with the direct ray as a function of frequency, hence multipath causes a frequency dependent signal distortion. Additionally, Doppler shift also distorts the radio waves. For example, if there is relative motion between the transmitter, reflectors and the receiver, the transmitted signal may experience a shift in frequency, either shifting higher or lower in frequency, further distorting the signal that is ultimately received.

It will be appreciated that phenomena that causes a change in the overall signal level (antenna gain, propagation loss and signal absorption) may be directly simulated using the programmable attenuators of the test system and as such, any desired scenario involving these effects may be simulated. For example, consider a typical wireless LAN transmitter and receiver situation. Each station may have a directional antenna, and the direct path between the two may be blocked by a wall or other obstruction. Appropriately setting a programmable attenuator for this scenario means (a) estimating the path loss between the two stations, (b) estimating the attenuation caused by the wall, and (c) computing the gain, relative to the antenna input port, of the antennas in the appropriate directions for each station.

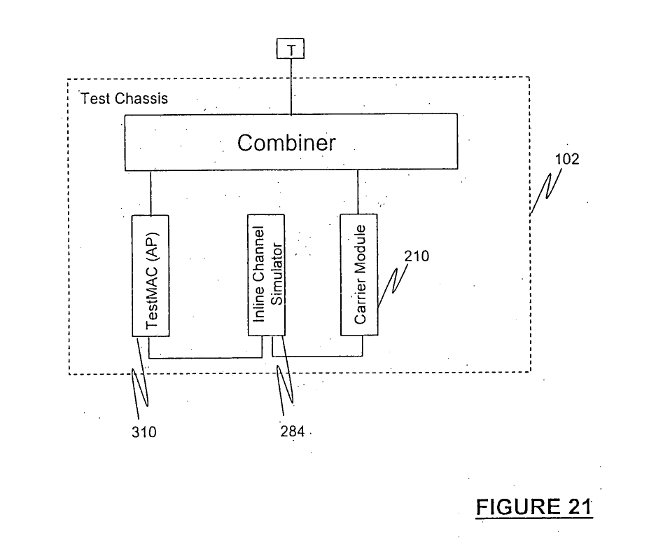

Once these values have been determined, the overall signal loss between the transmitter and receiver may be estimated by summing the individual losses, in dB. This advantageously produces the correct setting of the programmable attenuator between these wireless stations. In order to account for multipath and Doppler distortion, an external channel simulator may be connected, or an ICSM 284 may be used. For example, one possible configuration using the test system includes a TestMAC which is configured to simulate an Access Point. Referring to FIG. 21, a CM 210 is configured to operate a single NIC and an ICSM 284 may be installed in the chassis 200, although the ICSM 284 has no connection to the RF backplane. TestMAC 310 and CM 210 are configured to route the RF signal to a user-accessible connection, wherein external cabling provides the connections between the TestMAC 310, CM 210 and ICSM 284.

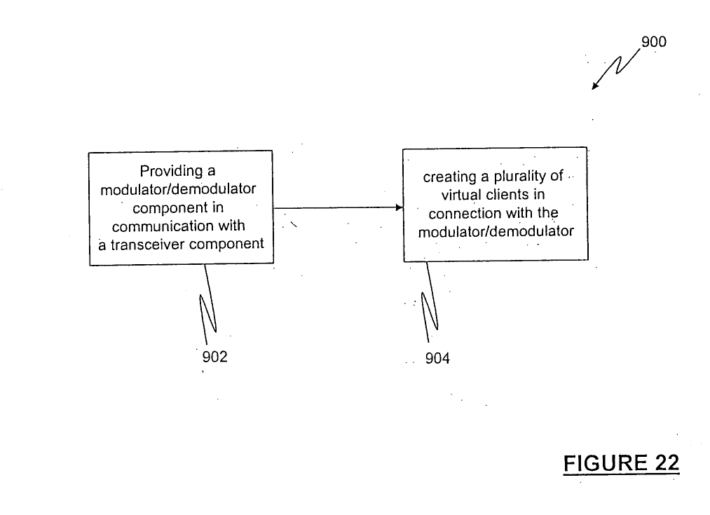

Turning now to FIG. 22, a block diagram describing a method of simulating traffic in a wireless network 900 is shown and discussed. As shown in block 902, a modulator/demodulator component is provided wherein the modulator/demodulator component is disposed to be in communication with a transceiver component. It will be appreciated that the transceiver component is capable of transmitting and receiving RF signals in the wireless network. A plurality of virtual clients are then created as shown in block 904, wherein the virtual clients are connected with the modulator/demodulator. Additionally, the virtual clients transmit and receive data frames in the wireless network in compliance with a selected wireless communications standard and wherein the virtual clients maintain individual state for communication protocol as required by the selected wireless communications standard.

It will be appreciated that the shielded enclosures and cables may be shielded using any shielding device suitable to the desired end purpose, such as a copper and/or aluminum enclosure and/or copper and/or aluminum mesh material. Moreover, it is contemplated that other shielding techniques may be employed as well, such as the use of ground planes, ferrites, etc. It is also contemplated that various known shielding materials and methods may be used singly or in combination with each other.

As described above, the method 900 of FIG. 22 may be embodied in the form of computer-implemented processes and apparatuses for practicing those processes. The method 900 of FIG. 22 may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) may be updated to implement the invention. The method of FIG. 22 may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Further features of the invention related to the testing of Network Interface Controllers (NICs) and other devices will now be disclosed. The present invention, including the Carrier Module 210 provides features for modular NIC device installation and novel shielding and isolation techniques.

A Network Interface Controller (NIC) is a piece of electronic hardware whose purpose is to translate between a computer's peripheral bus and the physical medium of the network. A peripheral bus is an input/output bus that connects peripherals to the computer or processor. A peripheral bus usually adheres to a standard, such as the Peripheral Component Interconnect (PCI) bus commonly used in desktop and laptop computers. PCMCIA, miniPCI, Cardbus and Universal Serial Bus (USB) and Firewire (IEEE 1394) are other peripheral buses commonly used for NICs. The network interface adheres to the networking standard interface, such as Ethernet.

A wireless NIC is no different, except that the physical medium is air, so there is not a solid connection between the NIC and the other devices in the network. Instead, the network signaling is conducted at radio frequencies, typically in the 2.4 GHz ISM band, or in the 5 GHz UNII bands. The radio signals are transmitted and received over the air through an antenna, usually integral with the NIC.

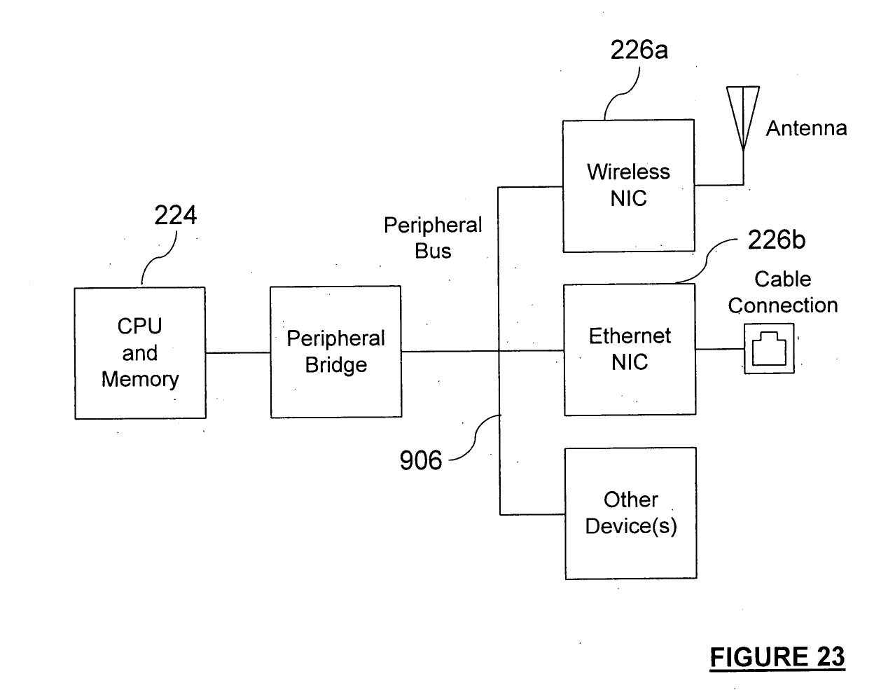

FIG. 23 shows a simplified drawing of a typical computer system and the relative placement of the peripheral components, including the Ethernet and wireless NICs 226. A peripheral bus, 906 provides communications between CPU 224 and the NICs 226. The NICs 226 can either be integrated with the main PC board of the computer, or computer and the NICs can be designed so the NIC is removable.

When testing the wireless NIC 226a, the antenna is usually bypassed and a direct RF cable connection is made to the NIC. It is also possible to use a connectionless RF probe for this purpose.

The wireless NIC 226a poses a problem when trying to test it. Because the NICs are typically intended as consumer products, test engineers need to operate the product in the same environment as the consumer, which is typically a PC running a version of the Microsoft Windows® operating system. However, an off-the-shelf PC does not provide the controlled environment needed for repeatable, interference-free testing.

A controlled environment, in addition to blocking interfering signals, makes it possible to precisely set the signal levels using attenuators. Without the level of isolation provided by the present invention, the wireless device under test can receive external wireless LAN signals at a level higher than allowed by the attenuator setting. This would defeat the purpose of the attenuator in setting precise, and potentially very low, signal levels.

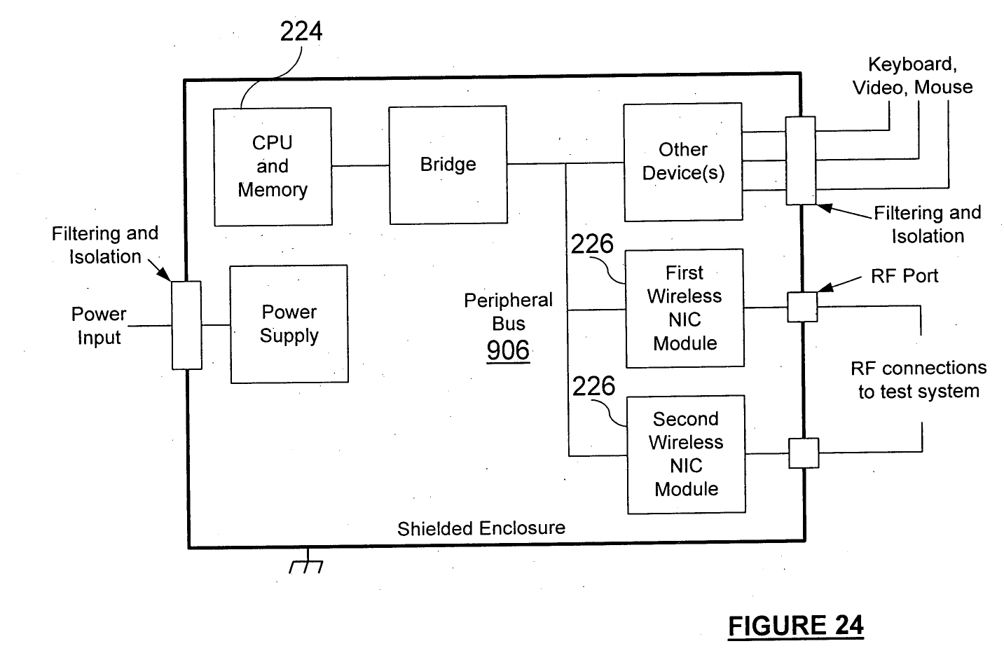

There are several possible solutions to this problem. One is to operate the entire PC and wireless device inside a RF-shielded enclosure, as shown in FIG. 24. There are several difficulties with this approach. First, enclosing the whole PC produces a new problem of how to bring the keyboard, mouse, display, wired network and other connections to the outside of the enclosure. This is simpler than shielding the peripheral bus, but leads to a bulky and expensive solution. Another problem makes this solution less viable: emissions from the PC itself may influence the NIC 226 operation and invalidate the test. Finally, this solution rules out the option to operate multiple wireless NICs 226 independently in the same PC environment, because even though the NICs are shielded from outside sources of interference, they could potentially interfere with each other and invalidate a test.

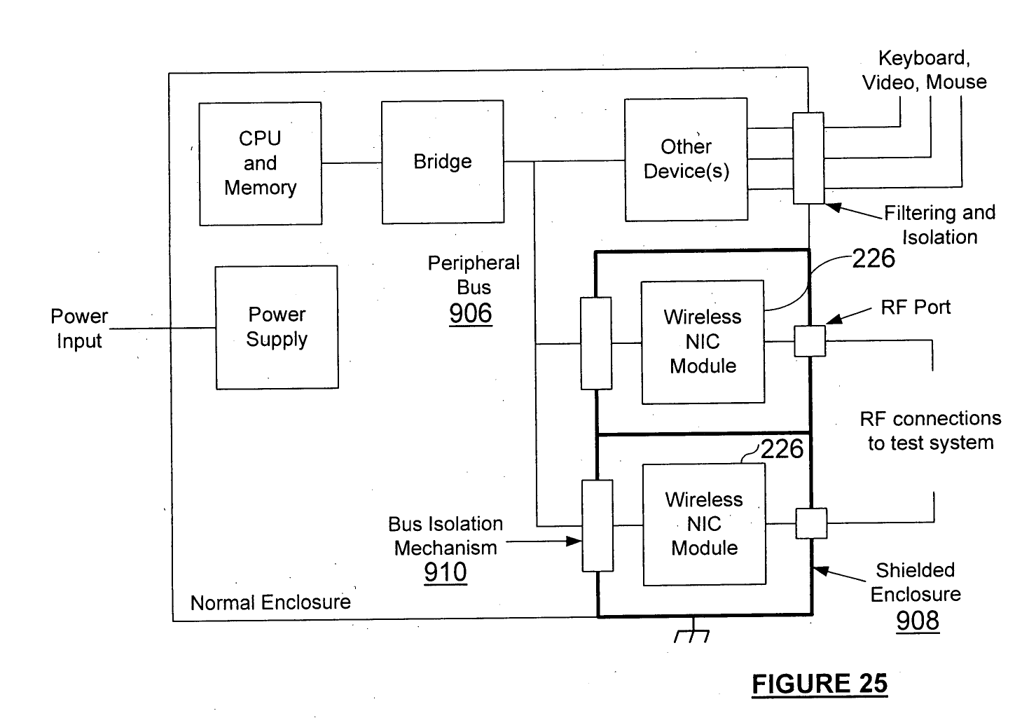

A second possibility would be to operate only the wireless NIC 226 within a shielded chamber 908, as shown in FIG. 25. The problem here is to allow the numerous peripheral bus signals 906 to pass between the PC and the inside of the shielded chamber 908.

One approach is to do this optically. The bus signals are converted to optical signals, passed over optical fiber through ports in the enclosure and regenerated by detectors on the other side. This operation is performed by a bus isolation mechanism 910.

This method is already employed for transmission of networking signals into and out of shielded chambers. However, networking signals are in a serial format and require a small number (one or two) of fiber optic connections. To pass the entire PCI bus through the enclosure wall would require a fiber optic connection for each of 53 digital signals. This is an expensive solution. A related technique would be to convert the bus signals from their natural parallel format to a serial format so that only one (or a couple of) fiber optic connection would be required. This has been done in the past. However, it suffers from the drawback that it is impossible to guarantee that the wireless NIC driver software normally provided with the NIC would operate, due to the non-standard nature of this hardware. Furthermore, even if could be made to work, it would be at the risk of being unable to operate the wireless NIC at its peak performance.

Another possibility, and one that is the subject of present invention, is to directly filter and shield the bus signals. Such a scheme needs to provide high attenuation of conducted and radiated signals in the wireless LAN frequency bands, while simultaneously passing a large number of high-speed digital signals with sufficient fidelity that the bus can still operate. This has significant advantages to the alternatives. Directly filtering the peripheral bus means that only the NIC needs to be shielded, not the whole computer. This reduces the physical volume that requires stringent and expensive RF shielding, and allows for the possibility that more than one shielded wireless NIC could be operated by the computer. With direct filtering, there is no need for an expensive and potentially incompatible conversion to optical signaling. To summarize, directly filtering the peripheral bus leads to a solution that is more compact and less expensive than other alternatives.

Another issue is that wireless NICs are built with different electrical interfaces. As mentioned before, a NIC can have any one of a number of host interfaces. It is desirable to be able to plug a wireless NIC employing any one of these host interfaces into the same test environment. One possibility is to provide an interface inside the shielded chamber for each interface type. This will be bulky and expensive, and will provide interfaces for which some customers will not be interested. A better method is to design a mechanism in which the NIC is installed on a carrier that has a bridge from the NIC's interface type (e.g., CardBus) to the host interface type (e.g., PCI). This alternative is described below.

Accordingly, there is a need, addressed by the present invention, for a method for providing the filtering and shielding necessary to achieve the desired level of isolation, while at the same time permitting installation of wireless NICs adhering to a variety of electrical interfaces a modular fashion.

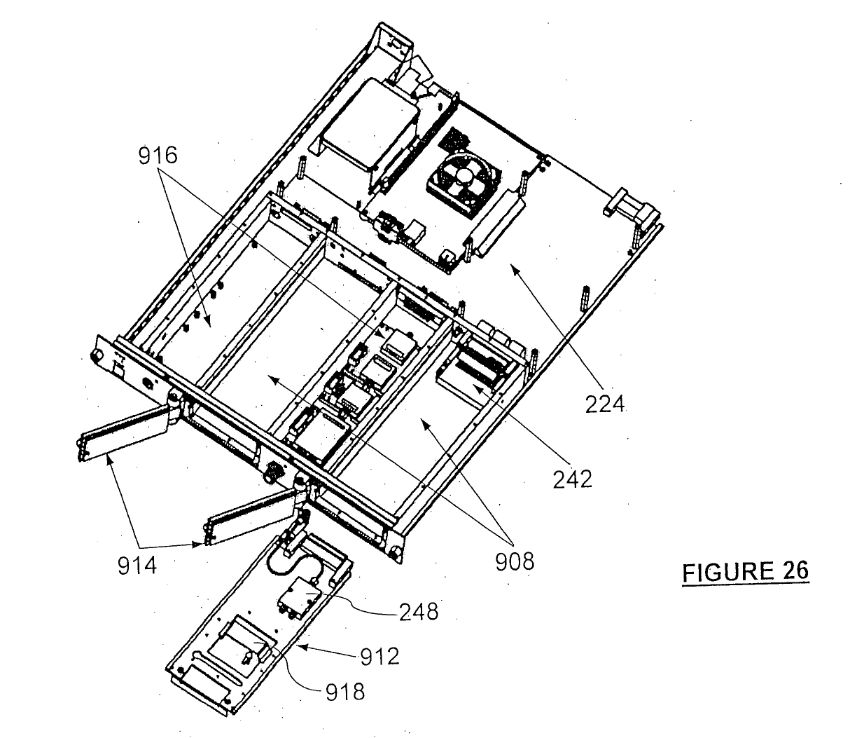

FIG. 26 shows a mechanical drawing of an embodiment in which the modular NIC installation system is used. Various covers are not shown in the drawing to permit viewing the chamber interiors. The NIC enclosure 908 is designed to accept a carrier card 912 that slides in through a user-accessible door 914 and plugs into a receptacle 242 at the back of the chamber. The receptacle 242 incorporates the peripheral bus filtering and isolation device, discussed below. Other chambers 916 contain RF attenuators 246 and switches 230 (see FIG. 6 for more details), while host computer 224 controls the whole system.

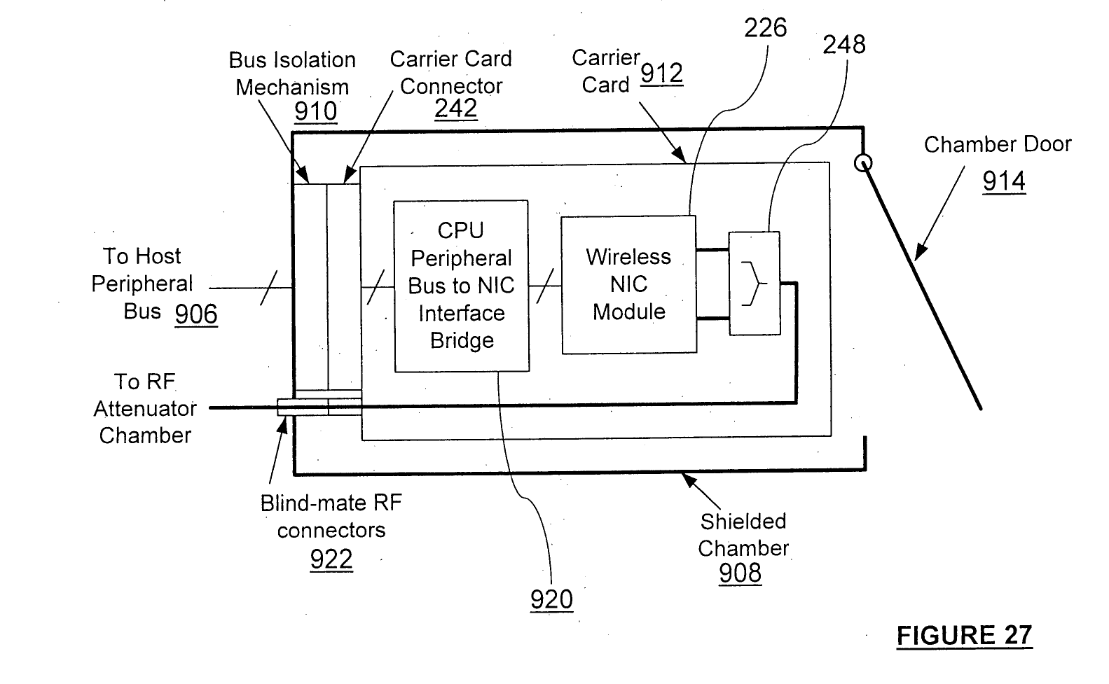

FIG. 27 depicts a schematic diagram of the carrier card 912 inside the chamber. The carrier card 912 is a printed circuit board on which is mounted the necessary mechanical fittings 918 FIG. 26 for mounting the NIC 226, and reinforced to form a robust platform for repeated insertion and removal from a shielded chamber.

The carrier card 912 FIG. 27 contains the peripheral bus bridge 920 integrated circuit (IC) to adapt the electrical interface and bus protocol requirements of the wireless NIC 226 to those of the host system. Signals from the host side of the bridge IC are attached to the pins of a multipin connector 242 at the connector end of the carrier card. Alternatively the carrier card may have an adaptor to match up bus signals but not include passive or active electrical components such as a bus bridge integrated circuit.

The carrier card 912 also contains RF cabling required to connect the RF interface of the wireless NIC 226 into the test system. It can also contain an RF combiner 248 for attaching NIC devices that employ diversity transmission or reception. Antenna diversity function enables a radio device to select its receive signal from at least two antennas or to combine signals from at least two antennas so as to optimize the signal quality. The RF cable passes to the connector end of the carrier card 912 and is connected to a blind-mate RF connector. This RF connector floats in its mounting fixture to allow for lateral motion of the carrier card 912 within its chamber as it is inserted and removed.

The carrier card 912 plugs into two connectors mounted at the back of the shielded chamber. One connector is the mate to the RF blind mate connector 922 on the carrier card. The other connector is a multipin connector 242 that carries the host bus peripheral interface signals. Although only two connectors are shown, greater or fewer connections are within the scope of the invention. For example, multiple RF connectors 922 may be provided for different RF signal paths. As another example, an Ethernet signal path is used to carry Ethernet data to the chamber for interfacing to a device within the chamber. In the case of RF testing a device with a PCI bus connections and an Ethernet connection but no RF transmitter, the Ethernet signal path may replace the RF connector.

The door 914 to the shielded chamber is hinged as shown in FIG. 26, and is covered with RF gasket material. When in the closed position, a thumbscrew held captive in the unhinged end of the door is tightened into a threaded hole in the chassis to produce an RF-tight seal.

Bridge ICs 920 are available for all commonly-used wireless NIC 226 interfaces, and a carrier card can be built for each one. Possibilities include but are not limited to PCMCIA, Cardbus, Universal Serial Bus (USB), IEEE 1394 (Firewire) and miniPCI (actually need no bridge chip is needed for miniPCI if the host bus is PCI). Once the user has installed a NIC 226 onto the appropriate carrier card 912 and made the appropriate RF connections, the user can swap NICs in the test system in a simple, tool-free manner.

The host peripheral bus signals leave the carrier card through a multipin connector 242 and pass through a device that prevents RFI from passing into or out of the shielded chamber, thus yielding the desired isolation. This novel device is part of the present invention and is described next.

The means for achieving the isolation depends on several combined techniques which together provide the necessary isolation. First, a means for blocking conducted emissions is required. This is achieved by two stages of low-pass filtering on every bus signal line.

Second, a means for blocking radiated emissions is required. The basic technique is to create signal paths that pass through openings that are much smaller than the wavelength of the RF signal we would like to block. There are several ways this concept is used in the present invention. Two isolation chambers are cascaded, one for each of the low-pass filter stages, and the methods for blocking radiated emissions are employed in each. Each of the techniques described provides some isolation, and together, they achieve a very high level of RF isolation.

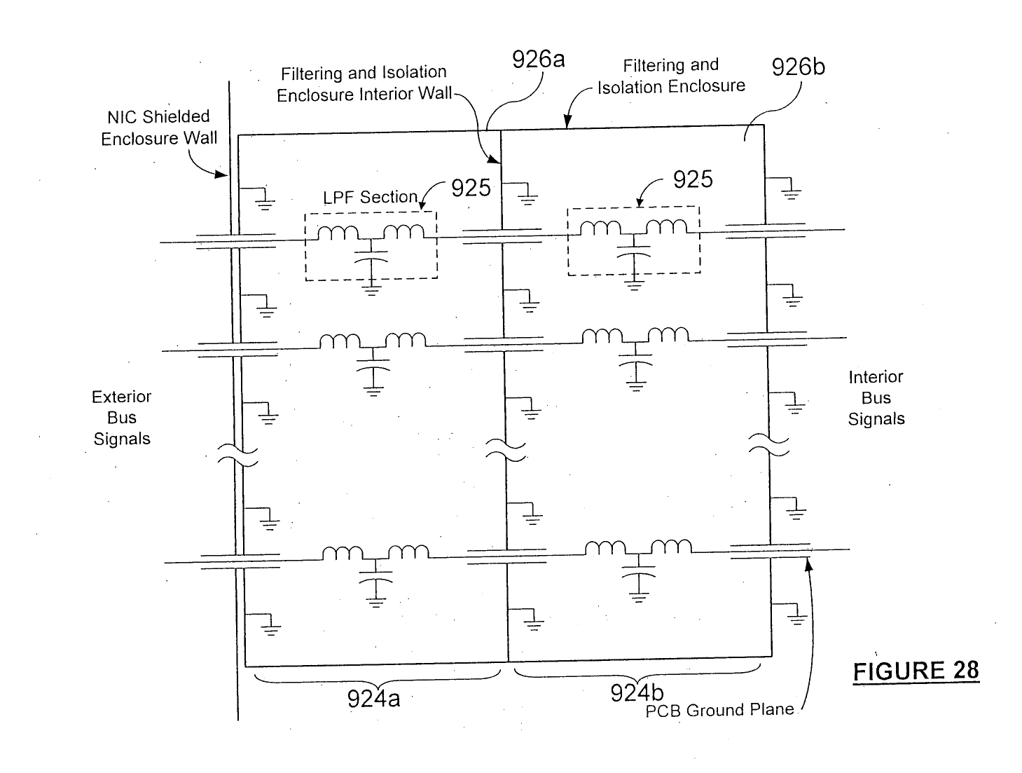

In one embodiment, the filtering and isolation components 910 are installed within the metal NIC enclosure 908, as shown in FIG. 27 and FIG. 28. Other variations are also possible, for example the isolation components 910 can be built as feed throughs in the wall of enclosure 908.

Conducted emissions are blocked by means of a cascaded low-pass filter network, as depicted in FIG. 28. Each section 924 includes of an LCT network with a cutoff frequency of 500 MHz. This cutoff proves to be high enough to allow undistorted passage of the bus signals. Two cascaded sections 924 proved to be enough to suppress RF signals in the 2.4 GHz band that might be present on the bus signals. Since such signals are unintentionally carried to the bus signals, they are already fairly low level. However, the present invention includes the ability to cascade as many chambers as needed to achieve the required RF suppression. Further description of cascading chambers and mechanical designs to facilitate such chambers are provided in co-owned co-pending patent application Ser. No. 10/912,823 filed on Aug. 6, 2004 and incorporated herein by reference.

FIG. 28 also depicts some of the physical construction required in this invention for blocking radiated emissions. Each filter section 924 is contained in its own grounded metal chamber 926, with the two-section chamber mounted with good electrical contact to the inside wall of the NIC enclosure.

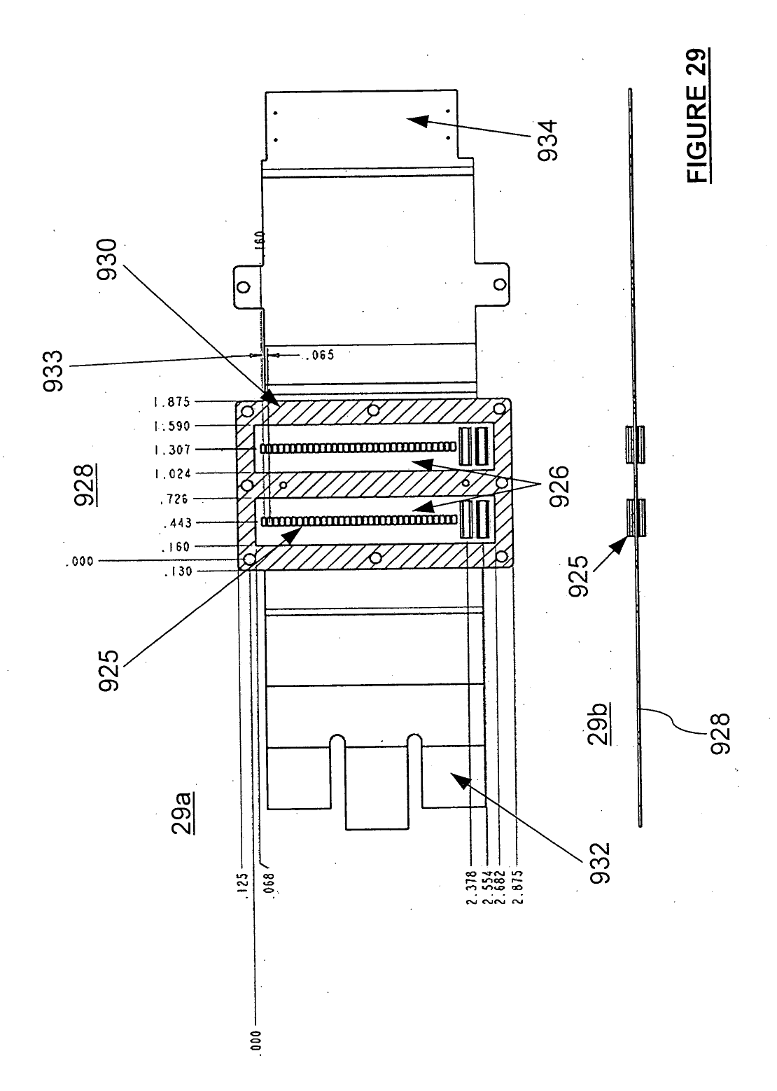

In one embodiment, the circuit itself is constructed on a thin, flexible, multilayer printed circuit board 928, FIG. 29. The flexible printed circuit board 928 provides a very compact and economical way to carry all the needed signals. The flexibility also avoids the need to precisely size the circuit board to ensure proper connections between the various connectors. A thin circuit board also provides a very low aperture signal path where the circuit board enters and exits the filtering and isolation enclosure. This is important because any gaps in the enclosure typically must be more than 50 times shorter than the wavelength of the undesired signal to provide sufficient attenuation. Sufficient attenuation at 6 GHz means the gap size should be smaller than 1 mm.

The low aperture signal path helps with signals of one polarization. However, signals of the orthogonal polarization have a gap as long as the width of the circuit board. Such signals are blocked through the construction of the circuit board itself, as described next.

The signal paths are built on an inner layer of the circuit board 928, while the top and bottom layers provide a ground plane. At the point where the circuit board 928 enters the enclosure, plated vias placed between the individual bus signal paths connect the top and bottom ground plane. When assembled, the upper and lower metal halves of the enclosure sandwich the circuit board and come into good electrical contact with the upper and lower ground planes of the circuit board. This serves to create a screen along the long dimension of the circuit board, and hence block radiated RF signals that would otherwise be passed because of their polarization.

FIG. 29 shows more details of the circuit board 928 construction. A surface-mount low pass filter 925 is placed in series with every signal line. A set of low pass filters 925 are placed in each chamber 926 formed by metal shells that sandwich the PC board along the hatched wall boundaries 930. In an illustrative embodiment, the low pass filters are Murata-Erie filters, part number NFL18ST50 7X1C3 with a cutoffat 500 MHz, although other filters, both passive and active, are within the scope of the invention. The filters can be surface mounted on one side of the circuit board 928 or on both sides as shown in FIG. 29B. The ends of the circuit board 932 and 934 expose all conductors in the bus for connection into the next stages.

Cascading of chambers 926 also provides additional isolation for radiated emissions. Conducted RF signals, while attenuated by the low pass filter section in a single chamber, are still conducted into one side of the filter section 924. At this point, these conducted RF signals can be radiated at low levels into the chamber 926 itself. For this reason, the second low pass filter stage is placed in a chamber of its own. The same low aperture signal path and plated vias as described above are used to pass the bus signals between chambers, hence providing another degree of isolation. If two chambers do not provide sufficient isolation for an application, cascading additional chambers is also possible and will produce additional isolation.

The bus filtering and isolation module is mounted over a hole in the NIC enclosure so that the end of the flexible PC board can be mounted to a connector outside the NIC enclosure. The module is mounted to the NIC enclosure using standard methods of RF isolation, such as RF gasket material. The bus filtering and isolation module is typically passes through the enclosure wall at point 933.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

1. A system for isolating a device that uses a peripheral bus for data communication, said system comprising:
an RF isolation enclosure, including an access door for insertion and removal of said device;
a peripheral bus connector inside said RF isolation enclosure, to connect to said device;
a peripheral bus signal path, connected to said peripheral bus connector, said peripheral bus signal path traversing from inside said RF isolation enclosure to outside of said RF isolation enclosure, said peripheral bus signal path to connect said device to a peripheral bus of a processor;
wherein said peripheral bus signal path includes RF filtering components to reduce undesired RF signals on said peripheral bus signal path as it traverses from inside said RF isolation enclosure to outside of said RF isolation enclosure.

2. The system of claim 1 wherein said RF isolation enclosure includes an RF port, to provide an RF signal path from said device inside said RF isolation enclosure to outside said RF isolation enclosure.

3. The system of claim 1 further including:
a carrier card component, sized to fit within said RF isolation enclosure, said carrier card component including a device connector, to connect to a peripheral bus connection on said device, and a bus signal path from said device connector to a second connector, said second connector to connect to said peripheral bus connector inside said RF isolation enclosure.

4. The system of claim 3 wherein said carrier card component is removable from said RF isolation enclosure via said access door, and wherein when said carrier card component is inserted into said RF isolation enclosure, said second connector on said carrier card component connects to said peripheral bus connector inside said RF isolation enclosure.

5. The system of claim 3 wherein said RF isolation enclosure includes an RF port, to provide an RF signal path from said device inside said RF isolation enclosure to outside said RF isolation enclosure, and wherein said carrier card component includes an RF connector to connect to said RF port, and an RF signal path from said RF connector to said device.

6. The system of claim 3 wherein said carrier card component includes an interface bridge component along said bus signal path between said device connector and said second connector, said interface bridge component to interface signals between said device and said peripheral bus.

7. The system of claim 6 further including a plurality of carrier card components, said carrier card components providing different bridge interface components for use with devices with different interfaces.

8. The system of claim 6 further wherein said interface bridge component interfaces signals between defined transmission protocols including PCMCIA, Cardbus, Universal Serial Bus (USB), IEEE 1394 (Firewire) and miniPCI.

9. The system of claim 5 wherein said RF signal path from said RF connector to said device on said carrier card component includes an RF signal combiner to provide RF signals to a plurality of RF connections on said device.

10. The system of claim 9 wherein RF signals to said plurality of RF connectors on said device are individually attenuated, to provide different RF signal strength to each of said plurality of RF connections on said device.

11. The system of claim 10 wherein providing different RF signal strength to each of said plurality of RF connectors on said device tests an antenna diversity feature of said device.

12. The system of claim 3 wherein said carrier card component includes a device holding component to physically hold said device to said carrier card component.

13. The system of claim 1 further including
a data connector inside said RF isolation enclosure, to connect to said device;
a data signal path, connected to said data connector, said data signal path traversing from inside said RF isolation enclosure to outside of said RF isolation enclosure, said data signal path to connect said device to a data network external to said RF isolation enclosure.

14. A system for isolating a device that uses a peripheral bus for data communication, said system comprising:
an RF isolation enclosure, including an access door for insertion and removal of said device;
a peripheral bus connector inside said RF isolation enclosure, to connect to said device;
a processor;
a peripheral bus signal path, connected to said peripheral bus connector, said peripheral bus signal path traversing from inside said RF isolation enclosure to outside of said RF isolation enclosure, said peripheral bus signal path to connect said device to a peripheral bus of said processor, wherein said peripheral bus signal path includes RF filtering components to reduce undesired RF signals on said peripheral bus signal path as it traverses from inside said RF isolation enclosure to outside of said RF isolation enclosure;
an RF port, to provide an RF signal path from said device inside said RF isolation enclosure to outside said RF isolation enclosure, wherein said RF signal path outside of said RF isolation enclosure then passes through an RF signal attenuation component; and
a carrier card component that can be inserted into said RF isolation enclosure, said carrier card component including:
a device connector, to connect to a peripheral bus connection on said device;
a bus signal path from said device connector to an interface bridge component, a second bus signal path from said interface bridge component to a second connector, said second connector to connect to said peripheral bus connector inside said RF isolation enclosure when said carrier card component is inserted into said RF isolation enclosure; and
an RF connector that automatically connects to said RF port when said carrier card component is inserted into said RF isolation enclosure, and an RF signal path from said RF connector to said device.

15. A carrier card component, to allow testing of a device that uses a peripheral bus for data communication, said carrier card component comprising:
a device holding component to physically hold said device to said carrier card component;
a device connector, to connect to a data port on said device;
an interface bridge component, electrically connected to said device connector, said interface bridge component to interface data signals between said device and said peripheral bus; and
a second connector, electrically connected to said interface bridge component, said second connector to connect to said peripheral bus.

16. The carrier card component of claim 15 further including:
an RF connector to connect to said device, to provide a path for RF signals between said device and a second RF connector on said carrier card component.

17. The carrier card component of claim 16 wherein when said carrier card component is placed within an RF isolation chamber, said second connector connects to said peripheral bus, and said second RF connector connects to an RF port.

18. The carrier card component of claim 15 wherein said path for RF signals includes an RF signal combiner to provide RF signals for a plurality of RF connections for said device.

19. The carrier card component of claim 15 further including a plurality of carrier card components, said carrier card components providing different bridge interface components for use with devices with different interfaces.

20. The carrier card component of claim 15 wherein said interface bridge component interfaces signals between defined transmission protocols including PCMCIA, Cardbus, Universal Serial Bus (USB), IEEE 1394 (Firewire) and miniPCI.

21. A method for attenuating undesired RF signals on a plurality of electrical signal paths, comprising:
for each signal path, passing said signal path through a first filtering component, said first filtering component positioned within a first RF shielded chamber, then passing said signal path along a shielded signal path to a second filtering component, said second filtering component positioned within a second RF shielded chamber, said second RF shielded chamber separate from said first RF shielded chamber.

22. The method of claim 21 further including mounting said filtering components and said RF shielded chambers on a flexible printed circuit board.

23. The method of claim 21 wherein said plurality of electrical signal paths includes a PCI bus.

24. The method of claim 21 further including the steps of:
connecting said plurality of electrical signal paths to a data port on a device;
placing said device within an RF isolation enclosure; and
for each one of said signal paths passing through said second filtering component, connecting to a second signal path passing from inside said RF isolation enclosure to outside of said RF isolation enclosure, to allow said device within said RF isolation enclosure to communicate with a processor outside of said RF isolation enclosure.

25. The method of claim 24 wherein each of said second signal paths passing from inside said RF isolation enclosure to outside of said RF isolation enclosure passes between shielded vias formed within said flexible printed circuit board.

26. The method of claim 22 wherein said shielded vias in conjunction with ground planes in said flexible printed circuit board form an RF shielded tunnel for each of said second signal paths.

27. A system for attenuating undesired RF signals on a plurality of electrical signal paths, comprising:
a printed circuit board including a plurality of signal paths, wherein each signal path passes through a first filtering component, said first filtering component positioned within a first RF shielded chamber, then each signal path passes through a shielded signal path to a second filtering component, said second filtering component positioned within a second RF shielded chamber, said second RF shielded chamber separate from said first RF shielded chamber.

28. The system of claim 27 wherein said printed circuit board includes a flexible printed circuit board.

29. The system of claim 27 wherein said plurality of electrical signal paths includes a PCI bus.

30. The system of claim 27 wherein said plurality of electrical signal paths are connected to a data port on a device that is placed within an RF isolation enclosure, and
each of said signal paths passing through said second filtering component are connected to a second signal path that passes from inside said RF isolation enclosure to outside of said RF isolation enclosure, to allow said device placed within said RF isolation enclosure to communicate with a second device outside of said RF isolation enclosure.

31. The system of claim 30 wherein each of said second signal paths passing from inside said RF isolation enclosure to outside of said RF isolation enclosure passes between shielded vias formed within said flexible printed circuit board.

32. The system of claim 28 wherein said shielded vias in conjunction with ground planes in said flexible printed circuit board form an RF shielded tunnel for each of said second signal paths.

33. A system for testing a wireless device with a plurality of antenna ports, said system comprising:
an RF isolation enclosure, including an access door for insertion and removal of said device;
a plurality of RF ports, to provide RF signal paths from each antenna port on said device inside said RF isolation enclosure to outside said RF isolation enclosure, wherein at least one of said RF signal path passes through an RF signal attenuation component; and
wherein said RF signal attenuation component is adjusted to provide a different RF signal strength at one of said plurality of antenna ports on said device.

34. The system of claim 33 wherein providing a different RF signal strength at one of said plurality of antenna ports on said device test an antenna diversity feature of said wireless device.

35. The system of claim 33 wherein each RF signal path connects to an RF switch to allow an external wireless device to be connected to a selected one of said plurality of antenna ports.
